(19) United States
(12) Patent Application Publication
(10) Pub. No.: US 2025/0066637 A1
(43) Pub. Date: Feb. 27, 2025

(54) FUSION BONDED EPOXY COATINGS AND PREPARATION METHOD AND APPLICATION THEREOF

(71) Applicant: KING FAHD UNIVERSITY OF PETROLEUM AND MINERALS, Dhahran (SA)

(72) Inventors: A. Madhan KUMAR, Dhahran (SA); Rami K. SULEIMAN, Dhahran (SA); Mohamed Abdrabou HUSSEIN, Dhahran (SA)

(73) Assignee: KING FAHD UNIVERSITY OF PETROLEUM AND MINERALS, Dhahran (SA)

(21) Appl. No.: 18/456,123

(22) Filed: Aug. 25, 2023

(51) Int. Cl. C09D 163/00; B05D 1/00

(52) U.S. Cl. CPC C09D 163/00; B05D 1/60; B05D 2202/10; B05D 2504/00

(57) ABSTRACT

A method for enhancing adhesion of a curable epoxy resin composition to a metal article includes applying a sol-gel mixture on the surface of the metal article and aging to form a sol-gel layer on the metal article and subsequently, electrospraying the curable epoxy resin composition on the sol-gel layer of the metal article, and curing the curable epoxy resin composition by heating thereby forming a fusion-bonded epoxy (FBE) layer on the sol-gel layer. The sol-gel layer is between the surface of the metal article and the FBE layer, and has an average thickness of 10 to 100 micrometers (μm). The FBE layer has a thickness of 70 to 130 μm.

### BACKGROUND

### Technical Field

The present disclosure is directed to a method for enhancing the adhesion of a curable epoxy resin composition to a metal article.

### Description of the Related Prior Art

The description of the related prior art provided herein is for the purpose of generally presenting the context of the disclosure. Work of the presently named inventors, to the extent described in this background section, as well as aspects of the description which may not otherwise qualify as prior art at the time of filing, are neither expressly nor impliedly admitted as prior art against the present invention.

Continuous advancements in polymer engineering have led to the establishment of alternate hybrid coating systems, aimed at addressing the current issues of corrosion on metallic surfaces. The continuous revolution in coatings technology and environmental regulations has particularly fostered the development of solvent-less coatings, such as powder, waterborne, and high-solid coatings [Krystel Pélissier and Dominique Thierry, Powder, and High-Solid Coatings as Anticorrosive Solutions for Marine and Offshore Applications? A Review, Coatings 2020, 10, 916]. Among these, powder coatings have garnered attention due to their advantages over conventional coatings, as they eliminate the need for volatile solvents and generate minimal waste during the application process. Therefore, powder coatings have been extended to various applications, including domestic, aeronautic, and automotive components.

Field observations have established the efficacy of fusion bonded epoxy (FBE) coatings as both external and internal coatings for steel pipelines and other steel structures. This recognition is attributed to their high chemical resistance, good compatibility with cathodic protection, effective mechanical features, and appropriate processing features. FBE coatings can either be utilized as standalone coats or as primary coats within multiple-coating structures. While FBE coatings exhibit remarkable performance, certain limitations do exist. Studies have found that the cathodic disbonding under cathodic protection, the interfacial adhesive forces between the base substrate and coating, and the diffusion of the corrosive ions are critical factors that can diminish the performance and lifespan of FBE coatings [Mohammad Ramezanzadeh, Zahra Sanaei, Bahram Ramezanzadeh, The influence of steel surface treatment by a novel eco-friendly praseodymium oxide nanofilm on the adhesion and corrosion protection properties of a fusion-bonded epoxy powder coating. J. Indus. Eng. Chem. 62 (2018) 427-435; and Deepak K. Kamde, Radhakrishna G. Pillai, Corrosion initiation mechanisms and service life estimation of concrete systems with fusion-bonded-epoxy (FBE) coated steel exposed to chlorides. Const. Buil. Mater. 277 (2021) 122314].

An approach for enhancing the interfacial adhesion strength between steel and FBE coatings involves employing surface treatment prior to the application of FBE coatings onto steel structures. Papavinasam reported that inadequate/improper surface preparation was the major cause of the encountered defects, such as blister formation in FBE-coated pipes, after five years of service [S. Papavinasam, Mitigation-External Corrosion. In Corrosion Control in the Oil and Gas Industry, 1st ed.; Gulf Professional Publishing: London, U K, 2014; Chapter 9; pp. 529-620.]. To establish robust and enduring adhesion interactions between FBE and metallic surfaces, a range of chemical treatments and mechanical procedures are reported. For instance, generating a surface profile via a blasting route and eliminating the oxide film through acid etching may be among the most common practices to create effective physical bonding between the organic coating and the metallic substrate. However, only through chemical treatments, such as phosphate and chromate conversion coatings, can strong chemical adhesion bonds be established on the metallic surface.

Researchers have recently concentrated on developing environmentally friendly chemical treatment methods, prompted by the hazardous and ecological complexities associated with phosphate and chromate coatings. Steel surfaces have been treated with cerium compounds before applying epoxy coatings [B. Ramezanzadeh, M. Rostami, The effect of cerium-based conversion treatment on the cathodic delamination and corrosion protection performance of carbon steel-fusion-bonded epoxy coating systems. Appli. Surf. Sci. 392 (2017) 1004-1016]. Moreover, the surface treatment of steel with neodymium (Nd) compounds prior to FBE coatings was also reported.

In recent times, surface treatment involving silane films presents a host of advantages, including cost-effectiveness, commendable anti-corrosion capabilities, and distinctive adhesion properties to a wide array of organic coatings, such as epoxies, acrylics, polyurethanes, and polyesters. As a result, utilizing organosilane primers at the interfaces between steel and epoxy is one approach to prevent steel corrosion. Although there are a few cases that exist regarding the application of steel in this context, there is still a challenge to develop a system that elevates the adhesion strength, fortifies mechanical durability, and enhances anticorrosion performance, particularly in chloride-laden environments.

In view of the foregoing, it is one objective of the present disclosure to provide a method for enhancing adhesion of a curable epoxy resin composition to a metal article using a sol-gel mixture. Another objective of the present disclosure is to provide a method for making and applying the sol-gel.

### SUMMARY

In an exemplary embodiment, a method for enhancing adhesion of a curable epoxy resin composition to a metal article is described. The method includes applying a sol-gel mixture on a surface of the metal article and aging to form a sol-gel layer on the metal article; electrospraying the curable epoxy resin composition on the sol-gel layer of the metal article; and curing the curable epoxy resin composition by heating thereby forming a fusion-bonded epoxy (FBE) layer on the sol-gel layer. In some embodiments, the sol-gel layer is between the surface of the metal article and the FBE layer. In some embodiments, the curable epoxy resin composition includes an epoxy monomer and a phenolic curing agent. In some embodiments, the FBE layer has a thickness of 70 to 130 micrometers (μm). In some embodiments, the sol-gel layer has an average thickness of 10 to 100 μm.

In some embodiments, the sol-gel layer has a porous, rough, textured surface containing irregular hills and valleys. In some embodiments, a plurality of pores are homogeneously distributed throughout the sol-gel layer.

In some embodiments, the sol-gel layer containing the irregular hills and valleys has an arithmetic mean height deviation (Rₐ) of 6.5 to 10.5 μm, a root mean square height (R_{q}) of 7 to 11 μm, a maximum peak height (Rₚ) of 30 to 40 μm, a maximum valley depth (Rᵥ) of −8 to −4 μm, and a ten-point height (RT) of 60 to 80 μm.

In some embodiments, the pores have an average diameter of 5 to 20 μm.

In some embodiments, the sol-gel layer contains one or more siloxane (—Si—O—Si—) bonds.

In some embodiments, the sol-gel layer on the metal article has a water contact angle (WCA) of 50 to 55 degrees) (°, and a glycerol contact angle (GCA) of 51 to 56°.

In some embodiments, the metal article contains at least one metal selected from the group consisting of a carbon steel (CS), a carbon steel alloy, and a mild steel.

In some embodiments, the metal article is made of CS, wherein the CS contains 0.1-0.6 wt. % Mn, 0.1-0.6 wt. % Si, 0.05-0.4 wt. % C, 0.01-0.1 wt. % Al, 0.01-0.1 wt. % Al, and Fe as a balance, as determined by Energy-dispersive X-ray (EDX) spectroscopy, in which each wt. % based on the total weight of the metal article.

In some embodiments, the metal article is part of a casing, a pipe, a pump, a screen, a valve, or a fitting of an oil or gas well.

In some embodiments, a mole ratio of the epoxy monomer to the phenolic curing agent is in a range of 10:1 to 1:1.

In some embodiments, after the curing the FBE of the FBE layer has a cross-linking degree of 60 to 95% based on a total number of the epoxy monomer and the phenolic curing agent.

In some embodiments, the curable epoxy resin composition contains at least one resin selected from the group consisting of a bisphenol A epoxy resin, a bisphenol F epoxy resin, a novolak epoxy resin, an aliphatic epoxy resin, a glycidylamine epoxy resin, an epoxidized vegetable oil, and a mixture thereof.

In some embodiments, the phenolic curing agent contains one or more phenolic hydroxyl groups.

In an exemplary embodiment, the electrospraying of the method further includes mixing the epoxy monomer and the phenolic curing agent to form the curable epoxy resin composition, dispensing, and atomizing the curable epoxy resin composition via a nozzle of a spray gun of an electrostatic spray unit to generate droplets of the curable epoxy resin composition at an output voltage of 80 to 100 kilovolts (kV). In some embodiments, a distance between the nozzle of the spray gun and the sol-gel layer is in a range of 100 to 150 millimeters (mm). The electrospraying of the method further includes passing the droplets through an electrostatic field generated by an electrode of the electrostatic spray unit onto a surface of the sol-gel layer of the metal article to form a coating layer on the surface of the sol-gel layer. In some embodiments, the passing is performed under an air pressure of 0.5 to 0.8 megapascal (MPa).

In some embodiments, the curing by heating is performed at a temperature of 150 to 250 degree Celsius (° C.).

In some embodiments, the method further includes preparing the sol-gel mixture by mixing one or more silane compounds (—Si—O—R) in a first solvent to form a silane mixture; and mixing an acid, a second solvent, and the silane mixture to form the sol-gel mixture. In some embodiments, the one or more silane compounds are hydrolyzed in the presence of the acid in the sol-gel mixture during the aging to form one or more silanol (—Si—O—H) compounds that can further react to form the sol-gel layer.

In some embodiments, the one or more silane compounds include (3-aminopropyl) trimethoxysilane (APTMS), dimethoxy-methyl-octadecylsilane (DMMOS), tetraethyl orthosilicate (TEOS), and 3-glycidyloxypropyl-trimethoxysilane (GPDMS).

In some embodiments, the first solvent is at least one of isopropyl alcohol (IPA), methanol, ethanol, and butanol. In some embodiments, the second solvent is at least one of methanol, and ethanol. In some embodiments, the acid is at least one of a hydrochloric acid (HCl), a sulfuric acid (H₂SO₄), a nitric acid (HNO₃), phosphoric acid (H₃PO₄), an acetic acid, and a hydrofluoric acid (HF).

In some embodiments, the surface energy of the FBE layer to the metal article is improved by 2.7 times compared to that of the FBE layer in the absence of the sol-gel layer.

In some embodiments, the FBE layer has a pull-off adhesion strength to the metal article in a range of 12 to 20 MPa, as determined by ASTM D4541.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a schematic flow chart depicting a method for enhancing adhesion of a curable epoxy resin composition to a metal article, according to certain embodiments;

FIG. 1B is a schematic flow chart depicting a method for electrospraying the curable epoxy resin composition, according to certain embodiments;

FIG. 1C is a schematic flow chart depicting a method for preparing a sol-gel mixture, according to certain embodiments;

FIG. 2 shows Attenuated Total Reflectance Infrared (ATR IR) spectroscopic curves for the FBE coatings on bare specimen and sol-gel coated steel specimens, according to certain embodiments;

FIG. 3A shows a surface profilometric analysis of the bare specimen, according to certain embodiments;

FIG. 3B shows a surface profilometric analysis of the sol-gel coated specimen, according to certain embodiments;

FIG. 4 shows water contact angle (WCA) and glycerol contact angle (GCA) results of the bare specimen, and sol-gel coated specimens, according to certain embodiments;

FIG. 5A and FIG. 5B shows scanning electron microscopy (SEM) images of a sol-gel coated steel surface, according to certain embodiments;

FIG. 5C shows a cross-sectional SEM image of a fusion-bonded epoxy (FBE)/bare specimen, according to certain embodiments;

FIG. 5D shows an SEM image of the FBE/bare specimen, according to certain embodiments;

FIG. 5E shows an SEM image of an FBE/sol-gel specimen, according to certain embodiments;

FIG. 5F shows a cross-sectional SEM image of the FBE/sol-gel specimens, according to certain embodiments;

FIG. 6 shows an SEM-Energy dispersive X-ray spectroscopy (SEM-EDS) analysis of a sol-gel coated carbon steel (CS) substrate, according to certain embodiments;

FIG. 7A shows load against indentation depth (ID) curves observed for the bare and sol-gel-coated steel surfaces, according to certain embodiments;

FIG. 7B shows hardness test results for the FBE coatings on the bare and sol-gel-coated steel specimens, according to certain embodiments;

FIG. 8A shows scratch-resistant analysis for the FBE coatings on the bare and sol-gel-coated steel specimens, according to certain embodiments;

FIG. 8B shows optical micrographs of scratch profiles of the FBE/bare substrates, according to certain embodiments;

FIG. 8C shows optical micrographs of scratch profiles of the FBE/sol-gel coated CS substrates, according to certain embodiments;

FIG. 8D shows the coefficient of friction (CoF) of the indent in the FBE coatings with the function of the applied force alongside the scratch length, according to certain embodiments;

FIG. 8E shows the penetration depth (Pd) of the indent in the FBE coatings with the function of the applied force alongside the scratch length, according to certain embodiments;

FIG. 9 shows wet and dry adhesion test results for the FBE coatings on bare and sol-gel coated steel specimens, according to certain embodiments;

FIG. 10A shows open circuit potential (OCP) values for the FBE coatings on the bare and sol-gel-coated steel specimens at different immersion periods, according to certain embodiments;

FIG. 10B shows linear polarization resistance (LPR) values for the FBE coatings on the bare and sol-gel-coated steel specimens at different immersion periods, according to certain embodiments;

FIGS. 11A and 11B are Nyquist plots showing electrochemical impedance spectroscopic (EIS) results of the FBE coatings on bare and sol-gel coated steel specimens in immediate immersion in NaCl medium, according to certain embodiments;

FIGS. 11C and 11D are Bode plots showing electrochemical impedance spectroscopic (EIS) results of the FBE coatings on bare and sol-gel coated steel specimens in immediate immersion in NaCl medium, according to certain embodiments;

FIG. 12A shows a Bode plot of the FBE coatings on bare and sol-gel-coated steel specimens after immersion for 7 days in in NaCl medium, according to certain embodiments;

FIG. 12B shows a Bode plot of the FBE coatings on bare and sol-gel-coated steel specimens after immersion for 14 days in in NaCl medium, according to certain embodiments;

FIG. 12C shows a Bode plot of the FBE coatings on bare and sol-gel-coated steel specimens after immersion for 21 days in in NaCl medium, according to certain embodiments;

FIG. 12D show a Bode plot of the FBE coatings on bare and sol-gel-coated steel specimens after immersion for 30 days in in NaCl medium, according to certain embodiments;

FIG. 13A shows charge transfer resistances (R_{ct}) results of FBE coatings on bare and sol-gel-coated steel specimens during the immersion of 30 days in NaCl medium, according to certain embodiments;

FIG. 13B shows R_{f} results of FBE coatings on bare and sol-gel-coated steel specimens during the immersion of 30 days in NaCl medium, according to certain embodiments;

FIG. 13C shows CPE_{dl} results of FBE coatings on bare and sol-gel-coated steel specimens during the immersion of 30 days in NaCl medium, according to certain embodiments;

FIG. 13D shows CPE_{f} results of FBE coatings on bare and sol-gel-coated steel specimens during the immersion of 30 days in NaCl medium, according to certain embodiments;

FIG. 14A shows micrographs of the FBE/bare coating after immersion of 30 days in NaCl solution, according to certain embodiments; and

FIG. 14B shows micrographs of the FBE/sol-gel coating after immersion of 30 days in NaCl solution, according to certain embodiments.

### DETAILED DESCRIPTION

When describing the present disclosure, the terms used are to be construed in accordance with the following definitions, unless indicated otherwise.

Embodiments of the present invention will now be described more fully hereinafter with reference to the accompanying drawings wherever applicable, in that some, but not all embodiments of the disclosure are shown.

In the drawings, like reference numerals designate identical or corresponding parts throughout the several views. Further, as used herein, the words “a,” “an” and the like generally carry a meaning of “one or more,” unless stated otherwise.

Furthermore, the terms “approximately”, “approximate”, “about,” and similar terms generally refer to ranges that include the identified value within a margin of 20%, 10%, or preferably 5%, and any values therebetween.

The use of the terms “include,” “includes”, “including,” “have,” “has,” or “having” should be generally understood as open-ended and non-limiting unless specifically stated otherwise.

A weight percent of a component, unless specifically stated to the contrary, is based on the total weight of the formulation or composition in which the component is included. For example, if a particular element or component in a composition or article is said to have 5 wt %, it is understood that this percentage is in relation to a total compositional percentage of 100%.

As used herein, the term “sol-gel process” generally refers to a chemical synthesis method for materials, e.g., resins, where an oxide network is developed through at least polycondensation reactions of a precursor in a liquid. In the present case, the precursor may include one or more silane derivatives, e.g., preferably alkoxysilanes. A finished product of the sol-gel process may be referred to as a “sol-gel material”, a “sol-gel processed material”, a “sol-gel product” or a “sol-gel processed product”.

As used herein, the term “epoxy resins” generally refers to polymers having one or more epoxy-functionalities, which may be in the form of a three-atom cyclic ether. In the present disclosure, the epoxy resins may undergo polymerization or cross-linking through a ring-opening reaction involving the one or more epoxy-functionalities. Typically, but not exclusively, these polymers contain repeating units derived from monomers having an epoxy-functionality. In addition, the epoxy resins may also contain, for example, silicone-based polymers containing epoxy groups, or organic polymer particles coated with or modified with epoxy groups, or particles coated with, dispersed in, or modified with epoxy-groups-containing polymers. The epoxy resins may have an average epoxy functionality of at least one, greater than one, or of at least two. Other ranges are also possible. Appropriate multifunctional epoxy resins, as an example, include those based on: phenol and cresol epoxy novolacs, glycidyl ether adducts of phenolaldehyde; glycidyl ethers of aliphatic diols; diglycidyl ether; diethylene glycol diglycidyl ether; aromatic epoxy resins; triglycidyl dialiphatic ethers, polyglycidyl aliphatic ethers; epoxidized olefins; brominated resins; aromatic glycidylamines; glycidylimidines and heterocyclic amides; glycidyl ethers; fluorinated epoxy resins.

As used herein the term “curing agent” generally refers to a chemical compound or substance that is added to a reactive mixture, such as a polymer resin, adhesive, or coating, to initiate and facilitate the process of curing. In the present disclosure, the curing agent, when mixed with an epoxy resin, creates a cured or hardened coating by generating cross-linked structures within the polymer. In some instances, curing agents are also referred to as hardeners.

As used herein, the term “corrosion” generally refers to a process of gradual deterioration or degradation of materials. There may be two types of corrosion, general or uniform attack corrosion, and galvanic corrosion. Typical or uniform corrosion happens, for instance, when the metal, e.g., iron, is in a humid environment, creating iron oxide and corroding. Galvanic corrosion occurs when two materials with differing bipolar indices or dislocations are in touch with each other or relatively close to one another when an electrolyte is present. The movement of electrons between materials is created by potential difference. In such a system, one material serves as the cathode and is more active (or less noble), while the other material serves as the anode and is less active (or more inert). The cathode corrodes more slowly than the anode, which corrodes rapidly.

As used herein, the term “fusion-bonded epoxy (FBE)” generally refers to a thermosetting epoxy powder resin that is applied onto a surface of a metal and then fused into the substrate through a curing process. In the present disclosure, the FBE provides corrosion protection by creating a barrier between the metal substrate and the surrounding environment, effectively preventing direct contact and exposure to moisture, chemicals, and other corrosive agents

As used herein, the term “contact angle (CA)” generally refers to a measure of the wettability of a solid surface. Hydrophobic solids have a CA above 90 (indicative of poor wetting), and hydrophilic solids have a CA below 90 (indicative of water-loving). The CA may be used for gauging the extent of cleanliness of a surface.

Aspects of the present disclosure are directed to methods for enhancing adhesion of a curable epoxy resin composition to a metal article, such that the deposition of sol-gel films at the interface between the metal surface and FBE coatings may improve the performance of the FBE coatings. Furthermore, the structure, surface morphology, and surface topography were characterized and disclosed for prepared sol-gel films on carbon steel (CS) and coated samples. Additionally, contact angle (CA) tests were employed to examine the surface free energy and wettability of the sol-gel coated CS substrates, and the extracted results were interrelated with the interface adhesion forces between FBE and CS surface.

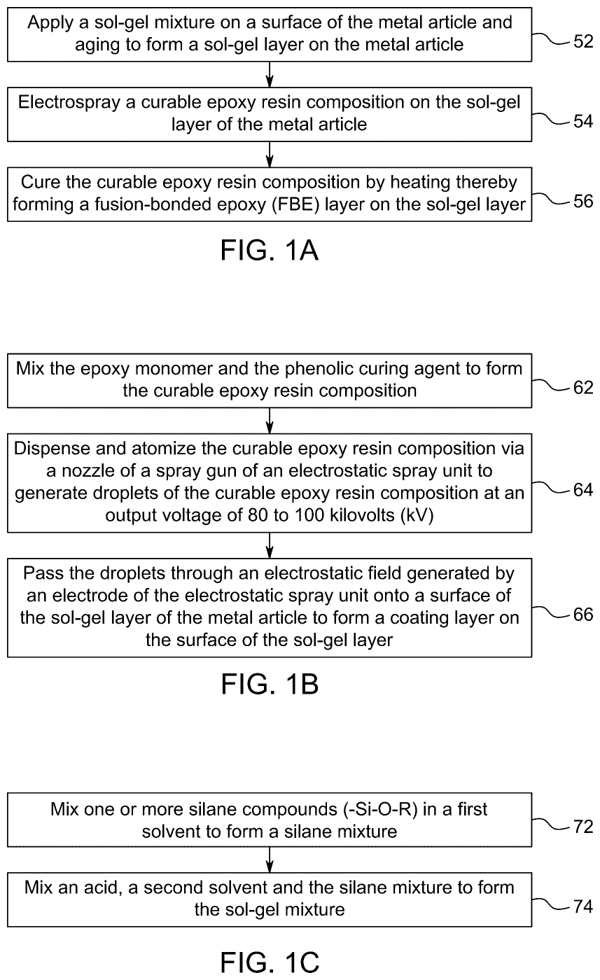

FIG. 1A illustrates a flow chart of method 50 for enhancing adhesion of a curable epoxy resin composition to a metal article. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

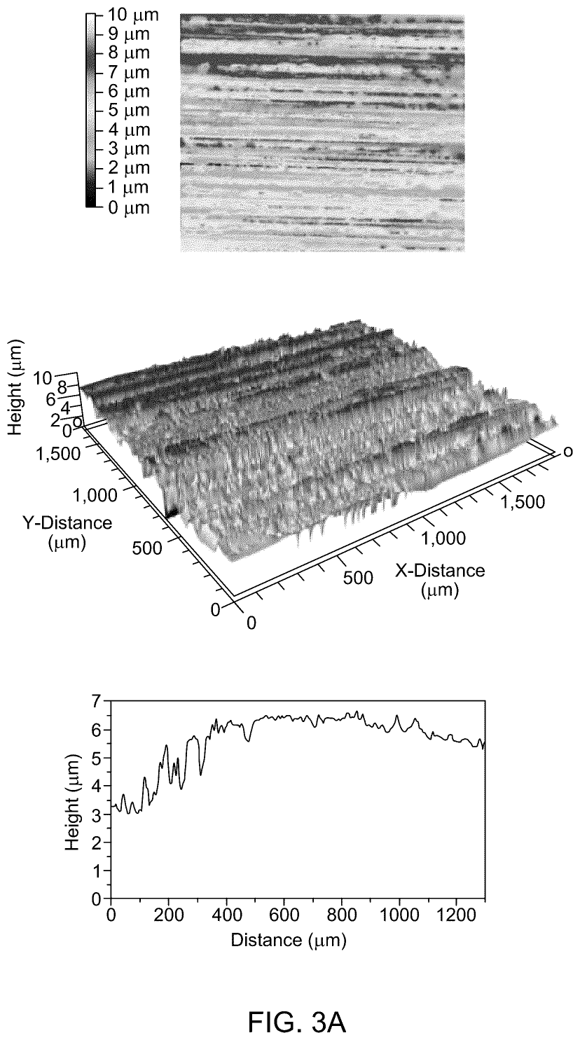

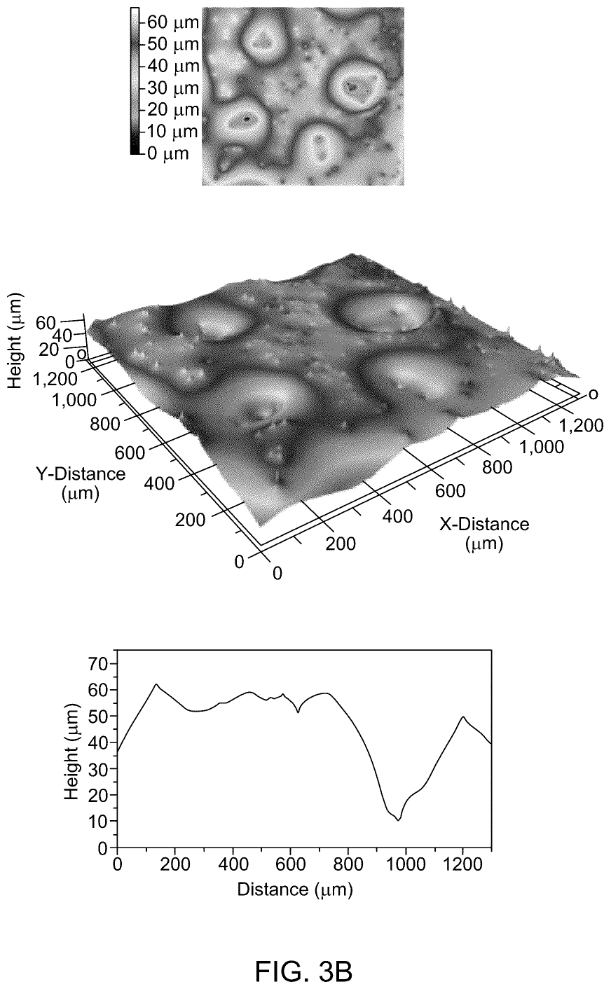

At step 52, the method 50 includes applying a sol-gel mixture on a surface of the metal article and aging to form a sol-gel layer on the metal article. In some embodiments, the sol-gel layer has a porous, rough, textured surface, including irregular hills and valleys. In some embodiments, the plurality of pores is homogeneously distributed throughout the sol-gel layer, as depicted in FIG. 3B.

As used herein, the term “rough surface” or “rough surface morphology” generally refers to the physical characteristics or features of a surface that deviate from smoothness or regularity. The term “rough surface morphology” may include unevenness, irregularities, and variations in height, shape, or texture of a surface at a micro or macro scale. In the present disclosure, the rough surface morphology of the sol-gel layer includes, but is not limited to, bumps, ridges, hills, valleys, peaks, or irregular shapes that may be randomly distributed or organized in a specific pattern. Additionally, the surface roughness may be determined by roughness average (Ra), root mean square (RMS) roughness, or peak-to-valley height. Roughness average (Ra) is calculated by averaging the surface roughness of at least 5, and preferably at least 10, representative locations spaced approximately evenly across the portion of the article carrying the sol-gel layer. In some embodiments, it is preferred to measure the thickness at representative points across the longest dimension of the portion of the article that is covered with the sol-gel layer. The standard deviation of roughness is found by calculating the standard deviation of the local average roughness across at least 5, and preferably at least 10, representative locations spaced approximately evenly across the portion of the article carrying the sol-gel layer. Arithmetic average roughness (Sa) is the areal (3D) equivalent of two-dimensional Ra. Sa generally refers to the average height of all measured points in the areal measurement.

In some embodiments, the sol-gel layer including the irregular hills and valleys has an arithmetic mean height deviation (Rₐ) of 6.5-10.5 μm, preferably 7-10, preferably 7.5-9.5, and preferably 8-9 μm. Other ranges are also possible. In some embodiments, the sol-gel layer including the irregular hills and valleys has a root mean square height (R_{q}) of 7 to 11 μm, preferably 7.5-10.5, preferably 8-10, and preferably 8.5-9.5 μm. Other ranges are also possible. In some embodiments, the sol-gel layer including the irregular hills and valleys has a maximum peak height (Rₚ) of 30-40 μm, preferably 31-49, preferably 32-48, preferably 33-47, preferably 34-46, preferably 35-45, preferably 36-44, preferably 37-43, preferably 38-42, and preferably 39-41 μm. Other ranges are also possible. In some embodiments, the sol-gel layer including the irregular hills and valleys has a maximum valley depth (Rᵥ) of −8 to −4 μm, preferably −7 to −5 μm. Other ranges are also possible. In some embodiments, the sol-gel layer including the irregular hills and valleys has a ten-point height (RT) of 60-80 μm, preferably 61-79, preferably 62-78, preferably 64-77, preferably 65-76, preferably 66-75, preferably 67-74, preferably 68-73, preferably 69-72, and preferably 70-71 μm. Other ranges are also possible.

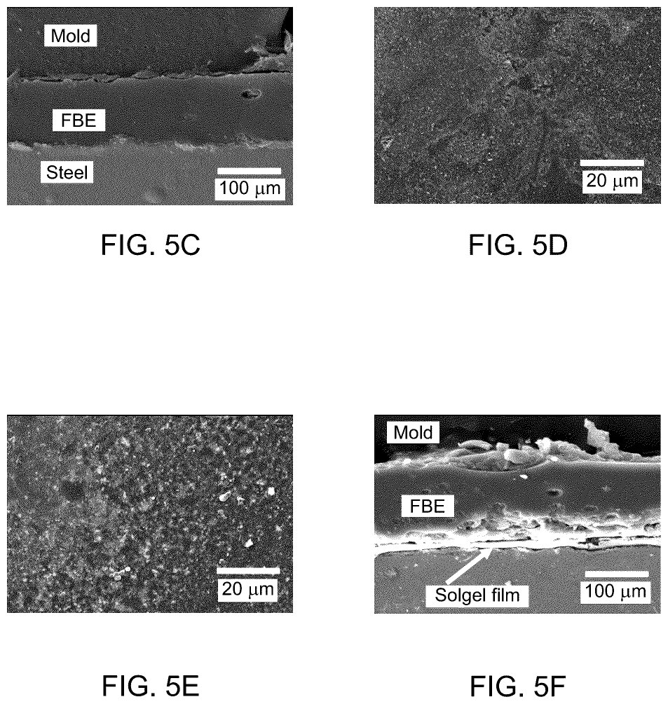

In some embodiments, the sol-gel layer includes one or more siloxane (—Si—O—Si—) bonds. The long-chain polysiloxane, being substantially linear, enables control of the porosity. In an embodiment, the plurality of pores distributed throughout the sol-gel layer have an average diameter of 5-20 μm, preferably 6-19, preferably 7-18, preferably 8-17, preferably 9-16, preferably 10-15, preferably 11-14, and preferably 12-13 μm, as depicted in FIGS. 3B, 5A and 5B. Other ranges are also possible. In an embodiment, the sol-gel layer has an average thickness of 10-100 μm, preferably 20-90, preferably 30-80, preferably 40-70, preferably 50-60 μm, as depicted in FIG. 3B. Other ranges are also possible.

As used herein, the term “contact angle,” or “water contact angle” generally refers to an average water contact angle (i.e., contact angles measured by Sessile Drop method) at room temperature. The result is obtained by averaging measurements of contact angles with at least 3 individual contact lenses. The water contact angle may be recorded on a contact angle goniometer (Attension, Biolin Scientific, Finland). In some embodiments, the contact angle was measured by placing 5 μL water drop on a surface of the sol-gel sample. As used herein, the term “glycerol contact angle” generally refers to an average glycerol contact angle (i.e., contact angles measured by Sessile Drop method) at room temperature. In some further embodiments, deionized water and glycerol may be employed respectively as the testing liquid to compute the surface free energy of the substrate.

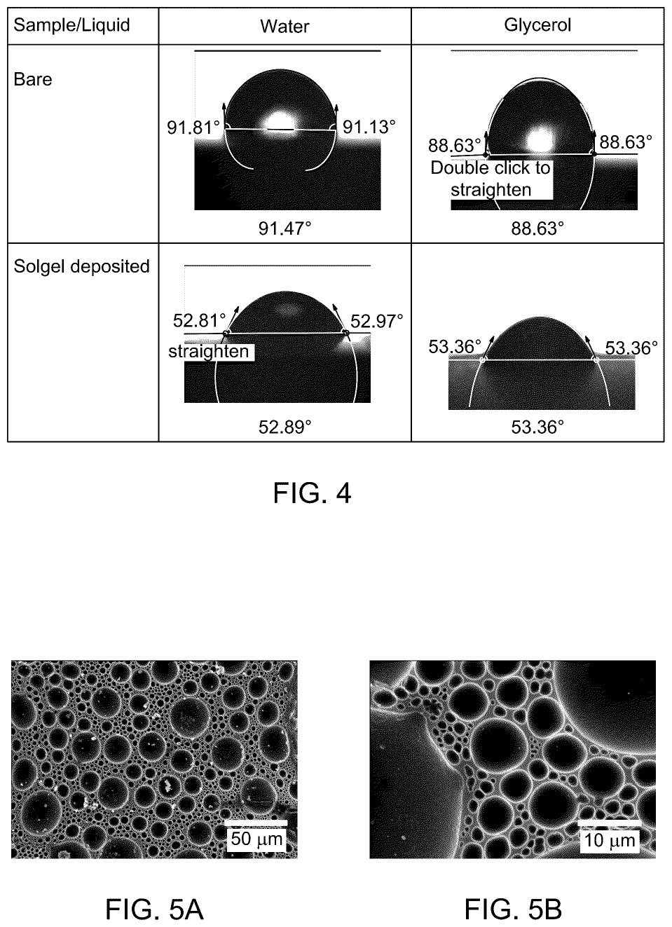

In some embodiments, the sol-gel layer on the metal article has a water contact angle (WCA) of 45-60°, preferably 50-55°, preferably 51-54°, preferably 52-53°, as depicted in FIG. 4. In a preferred embodiment, the sol-gel layer on the metal article has a WCA of 52.89°, as depicted in FIG. 4. Other ranges are also possible. In some embodiments, the sol-gel layer on the metal article has a glycerol contact angle (GCA) of 46 to 61°, preferably 51-56°, preferably 52-55°, preferably 53-54°, as depicted in FIG. 4. In a preferred embodiment, the sol-gel layer on the metal article has a GCA of 53.36°, as depicted in FIG. 4. Other ranges are also possible.

At step 54, the method 50 includes electrospraying the curable epoxy resin composition on the sol-gel layer of the metal article. Curable epoxy resins include polymers having one or more epoxy-functionality. In some embodiments, the curable epoxy resins are polymerized and/or cross-linked by a ring opening reaction of the epoxy functionality. Typically, but not exclusively, the polymers contain repeating units derived from monomers having an epoxy-functionality, but epoxy resins can also include, for example, silicone-based polymers that contain epoxy groups or organic polymer particles coated with or modified with epoxy groups or particles coated with, dispersed in, or modified with epoxy-groups-containing polymers. The epoxy resins may have an average epoxy-functionality of at least 1, greater than one, or of at least 2. In some embodiments, the curable epoxy resin composition includes at least one resin selected from the group consisting of a bisphenol A epoxy resin, a bisphenol F epoxy resin, a novolak epoxy resin, an aliphatic epoxy resin, a glycidylamine epoxy resin, an epoxidized vegetable oil, and a mixture thereof.

At step 56, the method 50 includes curing the curable epoxy resin composition by heating thereby forming a FBE layer on the sol-gel layer. In some embodiments, the curing by heating is performed at a temperature of 150-250° C., preferably 160, preferably 170, preferably 180, preferably 190, preferably 200, preferably 210, preferably 220, preferably 230, preferably 240, and preferably 250° C. Other ranges are also possible. In a preferred embodiment, the curing by heating is performed at a temperature of 200° C. to form the sol-gel layer. The sol-gel layer is between the surface of the metal article and the FBE layer.

The metal article includes any relatively lightweight metal and metal alloy. Suitable examples may include any one or a combination of the following: aluminum, aluminum alloy, magnesium, magnesium alloy, steel, 2024 aluminum; stainless steel, zinc or zinc alloy, titanium or titanium alloy, CS, carbon steel alloy. In a preferred embodiment, the metal article includes at least one metal selected from the group consisting of a CS, a carbon steel alloy, and a mild steel. In some embodiments, the metal article is made of CS, wherein the carbon steel includes 0.1-0.6 wt. % Mn, preferably 0.2-0.5, preferably 0.3-0.4 wt. %; 0.1-0.6 wt. % Si, preferably 0.2-0.5, preferably 0.3-0.4 wt. %; 0.05-0.4 wt. % C, preferably 0.1-0.35, preferably 0.15-0.3, and preferably 0.2-0.25 wt. %; 0.01-0.1 wt. % Al, preferably 0.05-0.095, preferably 0.075-0.08 wt. %; 0.01-0.1 wt. % Al, preferably 0.05-0.095, preferably 0.075-0.08 wt. % and Fe as a balance, as determined by Energy-dispersive X-ray (EDX) spectroscopy, and wherein each wt. % based on the total weight of the metal article.

In some embodiments, metal articles may form at least a part of line pipes, bends and fittings, valves, pumps, tapping saddles, manifolds, pipe hangers, ladders, mesh, rebar, cable and wire rope, I-beams, column coils, anchor plates, and chairs. In a preferred embodiment, the metal article is part of a casing, a pipe, a pump, a screen, a valve, or a fitting of an oil or gas well.

The sol-gel layer is between the surface of the metal article and the FBE layer. In an embodiment, the FBE layer has a thickness of 70-130 μm, preferably 80-120, preferably 90-110, preferably 95-100 μm. Other ranges are also possible. In a preferred embodiment, the average thickness of the FBE coatings was observed to be about 100±10 μm, in agreement with the Elcometer thickness measurements. In some embodiments, FBE has a cross-linking degree of 60-95%, preferably 65-90, preferably 70-85, preferably 75-80%, based on the total number of the epoxy monomer and the phenolic curing agent. Other ranges are also possible.

FIG. 1B illustrates a flow chart of method 60 for electrospraying the curable epoxy resin composition. The order in which the method 60 is described is not intended to be construed as a limitation, and any number of the described method steps can be combined in any order to implement the method 60. Additionally, individual steps may be removed or skipped from the method 60 without departing from the spirit and scope of the present disclosure.

At step 62, the method 60 includes mixing the epoxy monomer and the phenolic curing agent to form the curable epoxy resin composition. Suitable examples of phenolic curing agents include hydroxy-functionalized bisphenol F, hydroxy-functionalized novolac-modified bisphenol F, hydroxy-functionalized bisphenol AF, hydroxy-functionalized novolac-modified bisphenol AF, hydroxy-functionalized bisphenol A, hydroxy-functionalized novolac-modified bisphenol A, hydroxy-functionalized phenol and hydroxy-functionalized cresol. Preferred phenolic curing agents include hydroxy-functionalized bisphenol A, hydroxy-functionalized novolac-modified bisphenol A, hydroxy-functionalized phenol, and hydroxy-functionalized cresol. In an embodiment, the phenolic curing agent includes one or more phenolic hydroxyl groups. In some embodiments, other classes of curing agents that can be used in addition/instead of phenolic curing agent include aromatic amines, carboxylic acids, and carboxylic acid functional resins, guanidines, for example, dicyandiamide, imidazoles, and imidazole (epoxy) adducts, anhydrides, polyamides, dihydrazides and mixtures thereof. In an embodiment, the curable epoxy resin composition includes an epoxy monomer and a phenolic curing agent.

In some embodiments, a molar ratio of the epoxy monomer to the phenolic curing agent is in a range of 10:1-1:1, preferably 9:1-2:1, preferably 8:1-3:1, preferably 7:1-4:1, and preferably 6:1-5:1. In a preferred embodiment, the mole ratio of the epoxy monomer to the phenolic curing agent is 5:1. Other ranges are also possible.

At step 64, the method 60 includes dispensing and atomizing the curable epoxy resin composition via a nozzle of a spray gun of an electrostatic spray unit to generate droplets of the curable epoxy resin composition at an output voltage of 80-100 kilovolts (kV), preferably 85, preferably 90, preferably 95, and preferably 100 kV. Other ranges are also possible. In a preferred embodiment, the output voltage was 90 kV. In some embodiments, the distance between the nozzle of the spray gun and the sol-gel layer is in the range of 100-150 mm, preferably 110-140, and preferably 120-130 mm. Other ranges are also possible.

At step 66, the method 60 includes passing the droplets through an electrostatic field generated by an electrode of the electrostatic spray unit onto a surface of the sol-gel layer of the metal article to form a coating layer on the surface of the sol-gel layer. In some embodiments, the droplets of the curable epoxy resin composition are passed through the electrostatic field under an air pressure of 0.5-0.8 megapascal (MPa), preferably 0.55-0.75, preferably 0.6-0.7 MPa. Other ranges are also possible.

FIG. 1C illustrates a flow chart of method 70 for preparing the sol-gel mixture. The order in which the method 70 is described is not intended to be construed as a limitation, and any number of the described method steps can be combined in any order to implement the method 70. Additionally, individual steps may be removed or skipped from the method 70 without departing from the spirit and scope of the present disclosure.

At step 72, the method 70 includes mixing one or more silane compounds (—Si—O—R) in a first solvent to form a silane mixture. Suitable examples of silane compounds include (3-aminopropyl) trimethoxysilane (APTMS), dimethoxy-methyl-octadecylsilane (DMMOS), 3-glycidyloxypropyl-trimethoxysilane (GPDMS), methacryloxypropyltrimethoxysilane, 3-mercaptopropyltri (m) ethoxysilane, 3-glycidoxypropyltrimethoxysilane, 3-glycidoxypropyltriethoxysilane, tris(3-trimethoxysilylpropyl) isocyanurate, gamma-mercaptopropyltrimethoxysilane, beta-(3,4-epoxycyclohexyl)ethyltrimethoxysilane, gamma-isocyanatopropyltrimethoxysilane, (methacryloxymethyl)trimethoxysilane, isocyanatomethyl)trimethoxysilane, aminopropyltrimethoxysilane, N-(2-aminoethyl)-3-aminopropyltrimethoxysilane, N-(2-aminoethyl)-3-aminopropyltriethoxysilane, triamino-functional trimethoxysilane, bis(gamma-trimethoxysilylpropyl)amine, N-ethyl-gamma-aminoisobytyltrimethoxysilane, N-phenyl-gamma-aminopropyltrimethoxysilane, 4-amino-3,3-dimethylbutyltrimethoxysilane, (N-cyclohexylaminomethyl)triethoxysilane, (N-phenylaminomethyl)trimethoxysilane, and mixtures thereof. In a preferred embodiment, the silane compound is APTMS, DMMOS, TEOS, GPDMS, and/or combinations thereof.

At step 74, the method 70 includes mixing an acid, a second solvent, and the silane mixture to form the sol-gel mixture. In some embodiments, the first solvent is at least one of isopropyl alcohol (IPA), methanol, ethanol, and butanol; the second solvent is at least one of methanol, and ethanol; and the acid is at least one of a hydrochloric acid (HCl), a sulfuric acid (H₂SO₄), a nitric acid (HNO₃), phosphoric acid (H₃PO₄), an acetic acid, and a hydrofluoric acid (HF). In a preferred embodiment, the first solvent is IPA, the second solvent is ethanol, and the acid is HNO₃. The silane compounds are hydrolyzed in the presence of the acid in the sol-gel mixture during the aging to form one or more silanol (—Si—O—H) compounds that can further react to form the sol-gel layer.

The structures of the sol-gel film, the FBE coatings on bare specimen and sol-gel coated steel specimens of the present disclosure may be characterized by Attenuated Total Reflectance Infrared (ATR IR) spectroscopic, respectively. In some embodiments, the ATR IR are acquired in a range of 4500 to 400 centimeter inverse (cm⁻¹) at 4 cm⁻¹ resolution. At least 5, at least 10, or preferably at least 20 scans were carried out for each sample.

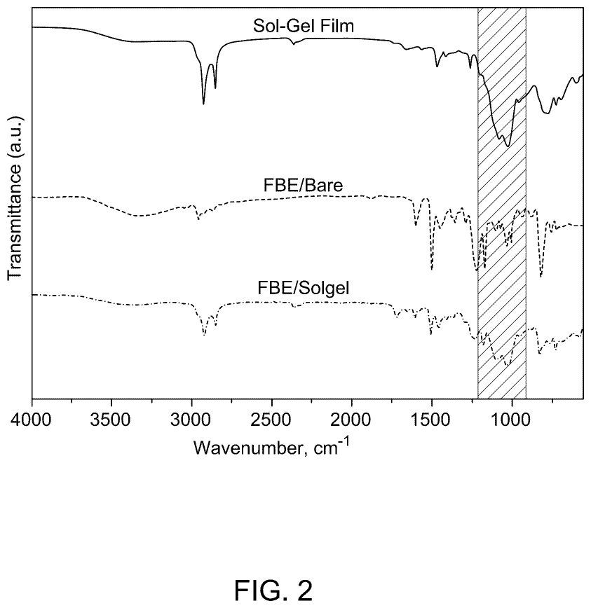

In some embodiments, the sol-gel film has peaks at 700 to 900 cm⁻¹, 950 to 1250 cm⁻¹, 1450 to 1550 cm⁻¹, 2700 to 2900 cm⁻¹, and 2900 to 3100 cm⁻¹, in the ATR IR spectrum, confirming its formation as depicted in FIG. 2. In some embodiments, the FBE coatings on bare specimen has peaks at 750 to 900 cm⁻¹, 950 to 1100 cm⁻¹, 1100 to 1300 cm⁻¹, 1450 to 1750 cm⁻¹, and 2800 to 3000 cm⁻¹, in the ATR IR spectrum, confirming its formation as depicted in FIG. 2. In some embodiments, the sol-gel coated steel specimens has peaks at 650 to 850 cm⁻¹, 950 to 1250 cm⁻¹, 1300 to 1750 cm⁻¹, 2700 to 2900 cm⁻¹, and 2900 to 3100 cm⁻¹, in the ATR IR spectrum, confirming its formation as depicted in FIG. 2.

Referring to FIG. 5C, the fusion-bonded epoxy (FBE)/bare specimen has a multilayered structure from a cross-sectional view. In some embodiments, each layer of the fusion-bonded epoxy (FBE)/bare specimen are distinct layer, and the FBE layer is above and adjacent to the bare specimen. Referring to FIG. 5D, the FBE/sol-gel specimen has an interfacial sol-gel film layer in the presence of the multilayered structure of the FBE/sol-gel specimen from a cross-sectional view. In some embodiments, the interfacial sol-gel film layer has a porous structure as depicted in FIG. 5E.

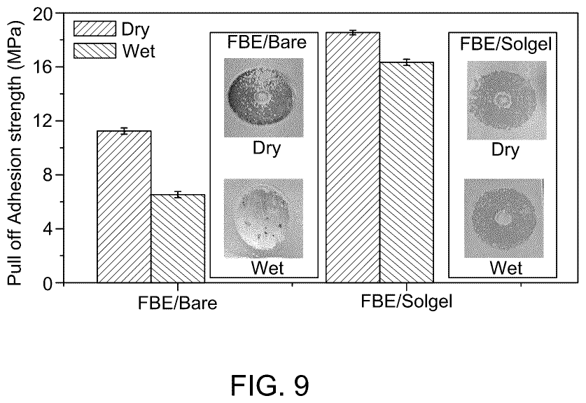

A metal article treated by the curable epoxy resin composition by the method of the present disclosure enhances the surface energy of the FBE layer to the metal article by 2.7 times compared to that of the FBE layer in the absence of the sol-gel layer. It is beneficial in improving the interfacial adhesion strength for the subsequent FBE coatings towards the CS surface. Referring to FIG. 9, in some embodiments, the FBE layer has a pull-off adhesion strength to the metal article in a range of 12-20 MPa, preferably 13-19, preferably 14-18, preferably 15-17 MPa, as determined by ASTM D4541 [Standard Test Method for Pull-Off Strength of Coatings Using Portable Adhesion Testers, ASTM D4541, which is incorporated herein by reference in its entirety].

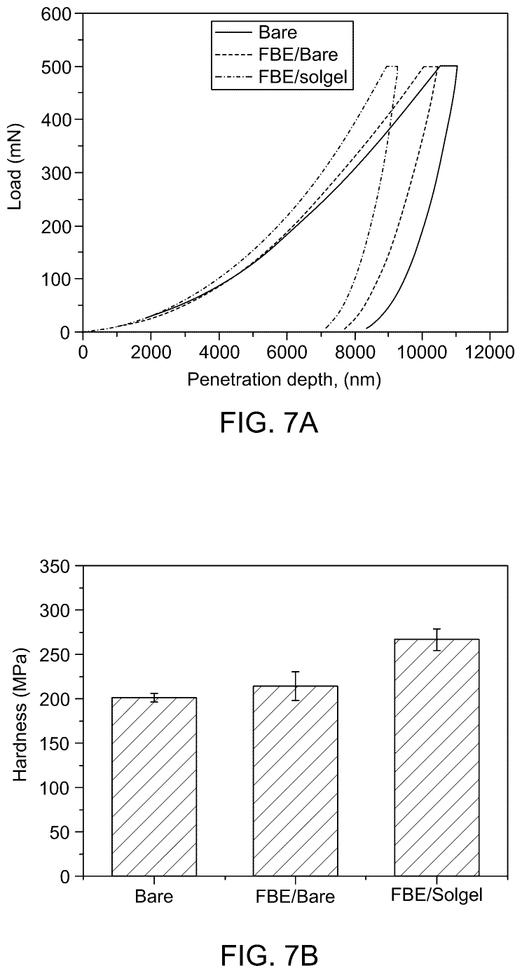

Referring to FIG. 7B, in some embodiments, the bare specimen has a hardness of 175 to 225 MPa, preferably 190 to 210 MPa, or even more preferably about 200 MPa. In some embodiments, the FBE layer on the bare specimen in the absence of the sol-gel layer has a hardness of 190 to 230 MPa, preferably 200 to 220 MPa, or even more preferably about 210 MPa, as depicted in FIG. 7B. In some embodiments, the FBE layer on the sol-gel-coated specimen has a hardness of 230 to 280 MPa, preferably 240 to 270 MPa, or even more preferably 250 to 260 MPa, as depicted in FIG. 7B. Other ranges are also possible.

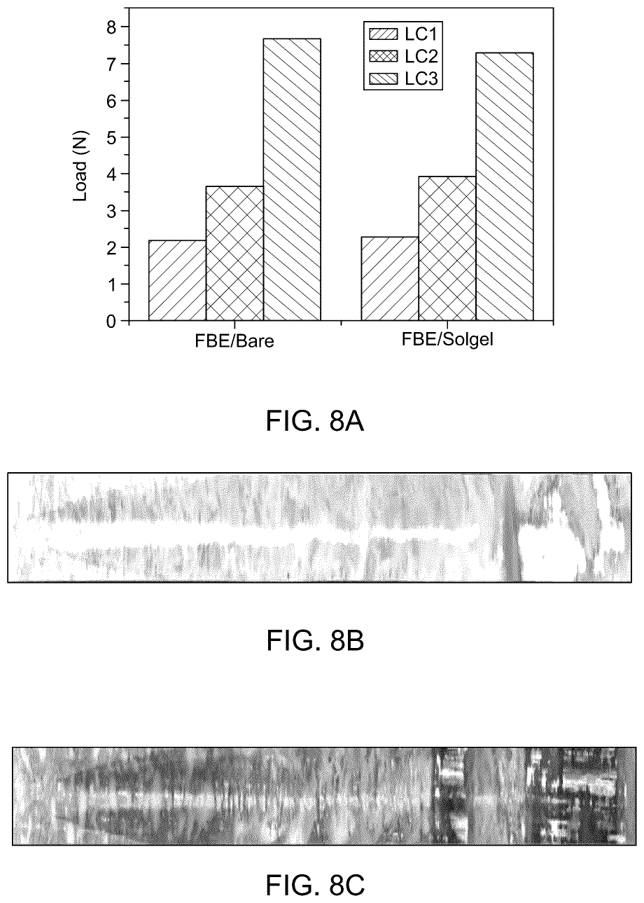

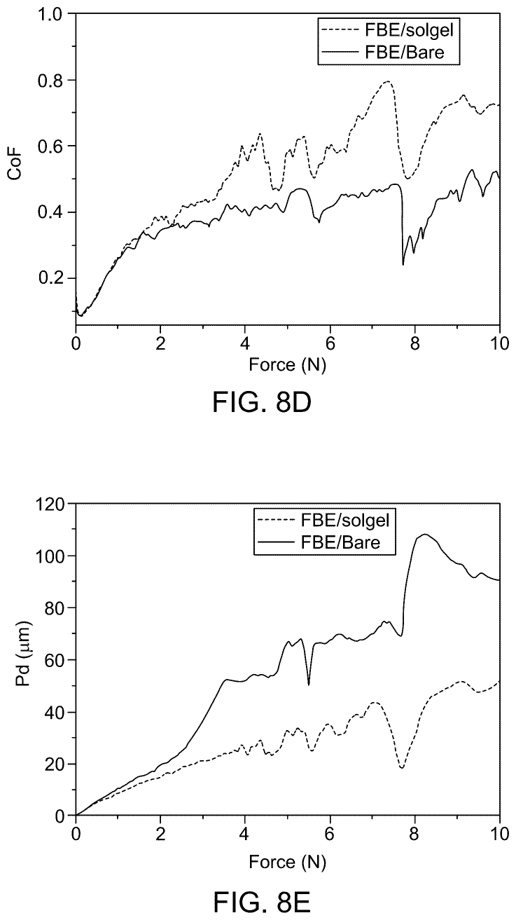

FIG. 8A, in some embodiments, the FBE layer on the bare specimen has a scratch-resistant value of 1 to 15 Newtons (N), preferably 2 to 10 N, or even more preferably 3 to 7 N. In some further embodiments, the FBE layer on the sol-gel-coated specimen has a scratch-resistant value of 1 to 15 Newtons (N), preferably 2 to 10 N, or even more preferably 3 to 7 N. Other ranges are also possible.

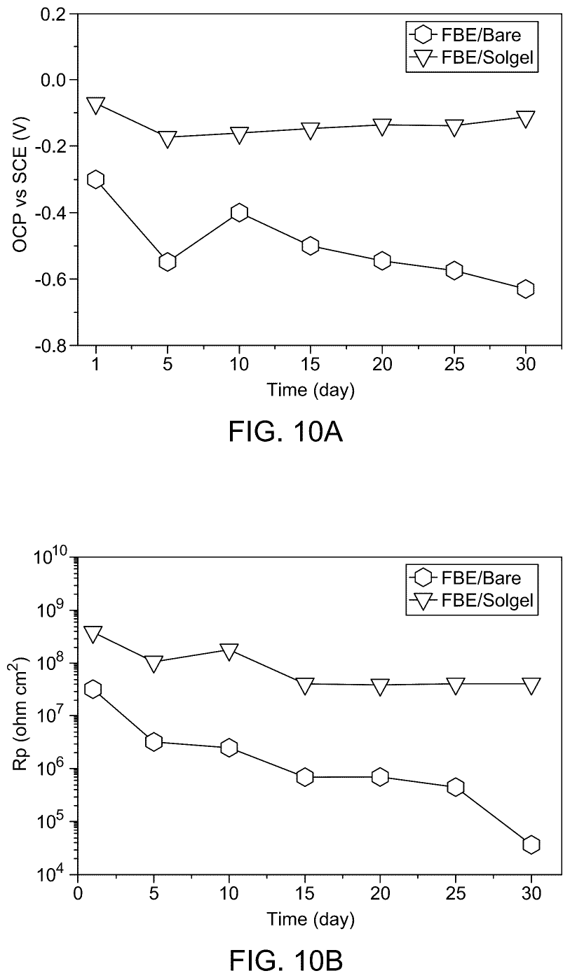

FIGS. 10A and 10B describe the open circuit potential (OCP) values, and linear polarization resistance (LPR) values for the FBE coatings on the bare and sol-gel-coated steel specimens at different immersion periods, respectively. In some embodiments, the corrosion tests were performed in a test cell assembly, e.g., preferably a Gamry Reference 3000 instrument.

In some embodiments, the test cell assembly includes a working electrode, a counter electrode, and a reference electrode. The working electrode may be the FBE coatings on the bare and sol-gel-coated steel specimens, respectively. The outer surface of the counter electrode may include an inert, electrically conducting chemical substance, such as platinum, gold, or carbon. The carbon may be in the form of graphite or glassy carbon. In one embodiment, the counter electrode may be a wire, a rod, a cylinder, a tube, a scroll, a sheet, a piece of foil, a woven mesh, a perforated sheet, or a brush. The counter electrode material should thus be sufficiently inert to withstand the chemical conditions in the electrolyte solution, such as acidic or basic pH values, without substantially degrading during the electrochemical reaction. The counter electrode preferably should not leach out any chemical substance that interferes with the electrochemical reaction or might lead to undesirable contamination of either electrode.

In some embodiments, the working electrode and the counter-electrode may be connected to each other by way of electrical interconnects that allow for the passage of current between the electrodes, when a potential is applied between them. In a preferred embodiment, the electrocatalyst (which forms the working electrode) and the counter electrode may be at least partially submerged in an electrolyte, e.g., preferably an aqueous solution, or even more preferably, a 3.5% sodium chloride (NaCl) solution, and are not in physical contact with each other. In an embodiment, the working electrode and the counter-electrode may have the same or different dimensions. The working electrode and the counter-electrode may be arranged as obvious to a person of ordinary skill in the art.

As used herein, the term “working electrode” generally refers to the electrode in an electrochemical cell/device/sensor on which the electrochemical reaction of interest is occurring.

As used herein, the term “counter-electrode”, generally refers to an electrode used in an electrochemical cell for voltammetric analysis or other reactions in which an electric current is expected to flow.

As used herein, the term “glassy carbon” generally refers to a non-graphitizing carbon that combines glassy and ceramic properties with those of graphite.

As used herein, the term “test cell” generally refers to a device capable of either generating electrical energy from chemical reactions or using electrical energy to cause chemical reactions.

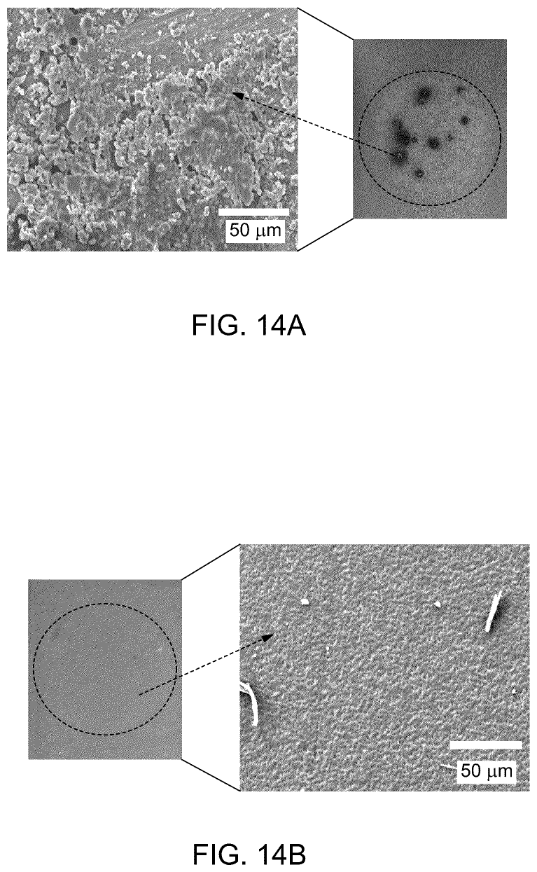

Referring to FIG. 14A, micrographs of the FBE/bare coating after immersion of 30 days in NaCl solution. The FBE/bare coating after the corrosion test has a rough surface containing a plurality of dispersed corrosion sites. In some embodiments, the plurality of dispersed corrosion sites have an average particle size of 1 to 10 μm, preferably 2 to 8 μm, preferably 3 to 7 μm, or even more preferably 4 to 6 μm. Other ranges are also possible.

FIG. 14B, micrographs of the FBE/sol-gel coating after immersion of 30 days in NaCl solution. The FBE/sol-gel coating after the corrosion test maintains a smooth surface in the absence of corrosion sites, and aggregated products. Other ranges are also possible.

The results of adhesion test showed that the incorporation of the sol-gel layer enhanced the interfacial adhesion of the FBE coatings. The application of FBE coatings on the surface of metal article in the presence of the sol-gel layer, e.g., silane films, shows improved adhesive strength. Additionally, the present disclosure also showed an enhanced anticorrosion performance for metal surface treated with sol-gel deposition and subsequently coated with the FBE. This is evidenced by the impedance values after a 30-days exposure. Furthermore, the present disclosure also described that the metal article substrate with the sol-gel films enhanced the surface energy by 2.7 times and improved surface hardness by 30% compared to the bare and interfacial adhesive strength of the subsequent FBE films. The improvement on the protective capacity, e.g., anti-corrosion ability of FBE coatings, preferably in the saline medium, is also described.

### EXAMPLES

The following examples demonstrate a method for enhancing the adhesion of a curable epoxy resin composition to a metal article, as described herein. The examples are provided solely for illustration and are not to be construed as limitations of the present disclosure, as many variations thereof are possible without departing from the spirit and scope of the present disclosure.

### Example 1: Raw Materials

The RS-14 low carbon steel (CS) panels (obtained from Q-Panel, UK) with a chemical composition revealed in Table 1 have been employed as base specimens (10 cm×2.5 cm×1.6 mm). Epoxy resin (as received epoxy resin flakes based on Bisphenol A, Razeen SR5097, Jana Chemicals, Saudi Arabia) and hardener powder (as received phenolic type hardener flakes, RAZEENCURE 3085, Jana Chemicals, Saudi Arabia) powder were undergone further processing to acquire a fine powder in a ball mill instrument (Planetary Micro Mill PULVERISETTE 7 premium line). Agate balls (diameter of 10 mm) were utilized with a rotational speed of 250 rpm and a powder-to-ball ratio of 1:10. After 4 hours of ball milling, the powder particles were subjected to a sieving process to get an average particle size of 75-125 μm.

TABLE 1
Elemental composition of CS specimens.

| Element | Fe | C | Mn | Si | Al | P | S |
|---|---|---|---|---|---|---|---|
| Wt. % | 99.01 | 0.19 | 0.32 | 0.34 | 0.04 | 0.05 | 0.05 |

### Example 2: Preparation of Sol-Gel Film on Steel Panels

The sol-gel film was prepared by taking 10 mL of each of silane precursors, dimethoxy-methyl-octadecylsilane (DMMOS), (3-aminopropyl) trimethoxysilane (APTMS), tetraethyl orthosilicate (TEOS), 3-glycidyloxypropyl) trimethoxysilane (GPDMS), and isopropyl alcohol (IPA) for 2 h in a covered beaker and under stirring. After that, 1 mL of a solution containing absolute ethanol and nitric acid (0.05N) (2:1 ratio by volume) was transferred to the silane to induce the hydrolysis and polycondensation reactions. The obtained sol-gel was aged for 2 days at room temperature before its use.

### Example 3: Preparation of Fusion-Bonded Epoxy (FBE) Coatings on Sol-Gel-Coated Steel Specimens

FBE coatings were deposited on bare and sol-gel-coated CS specimens using an electrostatic spray gun unit (Wagner PEM-X1 CG lab powder coating unit, Germany). The proportion between resin and hardener was fixed at a 5:1 ratio. The pre-determined parameters (output voltage of 90 kV, compressed air pressure of 0.5-0.8 MPa, the distance between the CS and spray gun of 100-150 mm) to deposit the appropriate FBE coatings were selected based on the preliminary experiments by inspecting its adhesion, thickness and visible defects. After applying the coating, the curing process was immediately done at 200° C. for 15 minutes. The thickness of the fabricated FBE coatings was monitored by the Elcometer thickness meter, and the range of thickness for the prepared coatings was about 100±10 μm. FBE coatings on bare and sol-gel deposited CS specimens were labeled as FBE/bare and FBE/sol-gel, respectively.

### Example 4: Characterization of FBE Coatings

Attenuated total reflectance-infrared (ATR-IR) spectroscopic studies were done on prepared FBE coatings with a choice of 400-4000 cm⁻¹. Scanning electron microscopic (SEM) investigation was carried out on the coated surface using JEOL JSM-6610 LV, operating at 20 keV accelerating voltage. Elemental composition on coated surfaces was also done using energy-dispersive X-ray (EDX) investigations. The topographical information on the coated CS specimens was attained by the optical profilometer (Bruker Nano GmbH, USA), and it works according to the interferometric phenomenon to give a 3D topographic micrograph of the coated CS specimens by scanning a part of around 2.2 mm×1.66 mm. The surface wettability analyses on the bare and sol-gel deposited CS substrates were done using the contact angle (CA) goniometer (Attension, Biolin Scientific, Finland). A 5 μL liquid drop. Deionized water and glycerol were employed as the testing liquid to compute the surface-free energies of the CS specimens.

### Example 5: Adhesion Tests on FBE-Coated Steel Specimens

To assess the pull-off adhesion strength of investigated FBE coatings with CS specimens, Hydraulic adhesion tests (Albuquerque Inc., U.S.A) were done according to the standard ASTM D4541. Initially, the thin film of suggested epoxy adhesive was applied on a metal dolly, then positioned on the coated specimens, and set aside for 24 h of curing. Afterward, the dolly was drawn. The highest force needed to remove the FBE coatings from the specimen was documented as a magnitude of adhesion between the FBE and the CS specimen.

### Example 6: Mechanical Characterization on FBE Coated Steel Specimens

To evaluate the mechanical features of the FBE coatings, a Micro indentation Tester (Anton Paar Micro Combi Tester: MCT3, Austria) was utilized by employing a Vickers indenter with the diamond tip (V-M 53). A 500 mN of indentation load was used for 10 s. Four experimentations were done at a 1 mm constant interval. The value of average hardness was estimated by following the Oliver-Pharr procedure [W. C. Oliver, G. M. Pharr, An improved technique for determining hardness and elastic modulus using load and displacement sensing indentation experiments, J. Mater. Res. 7 (1992) 1564-1583, which is incorporated herein by reference in its entirety]. The scratch resistance of the prepared FBE films was also investigated using the same instrument by changing the indenter to a Rockwell 0-138 diamond indenter (100 μm) attached to an acoustic sensor. The selected load was fixed from 0.03 to 10 N with a loading rate of 2.5 N/min over a 5 mm length and an acquisition rate of 30 Hz. A preliminary scan at 0.03 N was done before each scratch to identify the original surface of the sample.

### Example 7: Corrosion Test on FBE-Coated CS Specimens

Corrosion tests were electrochemically done in a coating test cell assembly with the Gamry Reference 3000 instrument. A 3.5% sodium chloride (NaCl) medium was utilized as an exposure solution to perform all the electrochemical corrosion tests. CS substrate (an exposed area of 1.76 cm²), the graphite stick, and the saturated calomel electrode (SCE) act as the working, auxiliary, and reference electrodes, respectively. Prior to all the electrochemical experiments, the value of open circuit potential (OCP) was observed for around 1800 s to achieve an electrochemically steady state. Linear polarization resistance (LPR) experiments were carried out for 30 days by sweeping the potential of +20 mV vs. OCP using the scanning speed of 0.2 m V/s. Electrochemical impedance spectroscopic (EIS) tests were performed on FBE-coated CS substrates in the selected frequencies (100 kHz to 1 mHz) through a 10 mV amplitude with 10 points per decade. To compute the attained EIS curves, the EIS simulation procedure was done using the Echem Analyst, which permitted to monitor of the Chi-square (x²) value to examine the eminence of the equivalent circuit simulation analyses.

### Example 8: Characterization of FBE Films on Sol-Gel Deposited CS Specimens

FIG. 2 presents the IR curves of prepared sol-gel films, FBE coatings on bare and sol-gel coated steel specimens, and the predictable characteristic functional groups are listed in Table 2.

TABLE 2
IR peaks of functional groups of the analyzed samples.

| Peaks (cm⁻¹) | Functional groups |
|---|---|
| 3590 | Stretching O—H of alcohol |
| 2985 | Stretching C—H of methylene |
| 1608 | Stretching C═C of aromatic rings |
| 1505 | Semicircle stretching C—C of phenylene |
| 1255 | Stretching C—O—C of aromatic ethers |
| 1183 | Stretching C—C of the phenyl group |
| 1109 | Stretching C—C of the aliphatic chain |
| 1055 | Stretching C—O—C of aliphatic ethers |
| 912 | Stretching C—O of oxirane group |
| 845 | Stretching C—O—C of oxirane group |

The two intense peaks at 1024 and 1082 cm⁻¹ were accompanied by the freshly produced Si—O—Si linkage from silane precursors, respectively. The peaks at 1258 and 795 cm⁻¹ appeared with the twisting C—H bond and the Si—O—Si bending vibrations, respectively. Further, the obtained peaks at 2852 and 2923 cm⁻¹ were ascribed to the C—H bonds of aliphatic groups from the silane networks, whereas the wide peak at 3344 cm⁻¹ is accompanied by either the N—H bond of the silane or the O—H bonds of Si—OH groups produced from the silane hydrolysis [Rami K. Suleiman, A. Madhan Kumar, Ahmad A. Sorour, Fadi A. Al-Badour, Bassam El Ali, Hybrid organosiloxane material/metal oxide composite as efficient anticorrosive coatings for mild steel in a saline medium. J. Appl. Polym. Sci. (2018); R. Suleiman, H. Dafalla, B. El Ali, Novel hybrid epoxy silicone materials as efficient anticorrosive coatings for mild steel. RSC Adv. 5 (2015) 39155-39167; R. K. Suleiman, T. A. Saleh, O. C. S. Hamouz, M. B. Ibrahim, A. A. Sorour, B. E. Ali, Corrosion and fouling protection performance of biocide-embedded hybrid organo siloxane coatings on mild steel in a saline medium. Surf. Coat. Technol. 324 (2017) 526-535, each of which is incorporated herein by reference in their entireties]. In the case of FBE coatings on bare CS samples, the two peaks at wavenumbers of 845 and 912 cm⁻¹ were accompanied by the C—O—C and C—O stretching vibrations from oxirane groups, respectively. The two signals that appeared at 1055 and 1255 cm⁻¹ were allocated to the aliphatic and aromatic ether's stretching vibrations, respectively [Shan Qian, Y. Frank Cheng, Degradation of fusion bonded epoxy pipeline coatings in the presence of direct current interference. Prog. Org. Coat. 120 (2018) 79-87, which is incorporated herein by reference in its entirety]. The two peaks at 2985 cm⁻¹ and 3590 cm⁻¹ were attributed to the C—H tension from the methylene group and the O—H group of the epoxy matrix, respectively [G. Gupta, N. Birbilis, A. B. Cook, A. S. Khanna, Polyaniline-lignosulfonate/epoxy coating for corrosion protection of AA2024-T3, Corros. Sci. 67 (2013) 256-267, which is incorporated herein by reference in its entirety]. In the case of FBE deposited on sol-gel coated steel samples, along with the relevant peaks obtained for the epoxy chain, a slight change in the Si—O—Si peak from 1024 to 1032 cm⁻¹ and a decreased intensity of the Si—O—Si peak of about 795 cm⁻¹ were obtained. This observation revealed that the interphase silane film is slightly condensed after interacting with the epoxy matrix. Silane precursor consists of alkoxysilane groups, which could interact with the CS surface through one side, and amine groups, which could interact with the epoxy matrix at another end. The chemical interaction between silane precursor (γ-APS) and epoxy resin through covalent bridging linkage was examined by Diodjo and research team [Madeleine R. Tchoquessi Diodjo, Lena ïk Belec, Emmanuel Aragon, Yoann Joliff, Lise Lanarde, and Francois-Xavier Perrin, Silane Coupling Agent for Attaching Fusion-Bonded Epoxy to Steel. ACS Appl. Mater. Interfaces 5 (2013) 6751-6761, which is incorporated herein by reference in its entirety]. The generally recognized phenomenon for enhancing the interfacial adhesion of polymeric coatings through silane films is elucidated using interfacial coupling.

A surface profilometric image of bare and sol-gel coated FBE coatings on bare and sol-gel coated steel is presented in FIG. 3A and FIG. 3B, respectively. The bare steel surface (FIG. 3A) displayed the plain surface with unidirectional homogeneous grooves that can be obtained during the surface preparation. Sol-gel coated steel surface (FIG. 3B) showed the homogeneous porous topography with pointedly higher surface roughness by showing many pores (diameter of about 5-20 μm), hills, and valleys, providing an active surface. Generally, the surface profile is efficiently regulated by the variation in the dispersion of micro defects such as pores and cracks on the substrate's surface, intensifying the adhesion sites. Thus, the interfacial adhesion between FBE and CS could be effectively enhanced by producing high roughness on the metallic surface. The extracted surface topographic parameters from line profile surface analyses are presented in Table 3.

TABLE 3
Surface roughness parameters of bare and sol-gel coated
CS specimens.

| Substrates | Rₐ (μm) | Rₚ (μm) | R_{q} (μm) | R_{T} (μm) | Rᵥ (μm) |
|---|---|---|---|---|---|
| Bare | 0.152 | 1.568 | 0.251 | 5.892 | −3.872 |
| Sol gel | 8.568 | 35.284 | 9.271 | 68.214 | −5.842 |

Surface roughness parameters, including the maximum peak height (Rp), arithmetic mean height deviation (Rₐ), root mean square height of the surface (R_{q}), maximum valley depth of (Rᵥ), and ten-point height (RT) are existing to estimate the surface roughness of metallic materials. Among the parameters available, the values of R_{q} and Rₐ are considered important characteristics explaining the surface profile as they specify variation extending from a plane surface by continuously scanning a surface profile. Initially, bare CS substrate showed lesser Rₐ and R_{q} values (Table 3); however, after sol-gel coating, these values were remarkably raised to about 30 μm. Further, the Rz value is commonly estimated by scanning the five highest and lowest peaks based on the straight surface profile, thus, observing R_{z} signs the surface heterogeneity/irregularities on the substrate's surface. From the values of R_{z}, it can be understood that the FBE/sol-gel specimens showed a uniform and high roughness surface profile. It has been recognized that the high roughness facilitates the formation of an effective chemical and physical interface between the base metal and subsequent coating, enhancing the interphase strength of coating/metal, viz., the mechanical interlocking arrays.

CA measurements were employed in this study to estimate the surface hydrophilicity of bare and sol-gel deposited steel specimens. Further, surface energy was computed using the Owens-Wendt method [Z. Zhong, S. Yin, C. Liu, Y. Zhong, W. Zhang, D. Shi, C. A. Wang, Surface energy for electroluminescent polymers and indium-tin-oxide. Appl. Surf. Sci. 207 (2003) 183-189, which is incorporated herein by reference in its entirety], as discussed elsewhere [M. A. Hussein, B. Yilbas, A. Madhan Kumar, R. Drew, N. Al-Aqeeli, Influence of laser nitriding on the surface and corrosion properties of Ti-20Nb-13Zr alloy in artificial saliva for dental applications. J. Mater. Eng. Perform. 27 (2018) 4655-4664, which is incorporated herein by reference in its entirety]. Bare steel surfaces (FIG. 4) exhibited a CA of 91.47° and 88.63° with water and glycerol, respectively. The calculated surface free energy for bare steel was 17.38 mJ/m². On the other hand, sol-gel deposited steel (FIG. 4) showed a CA of 52.89° and 53.36 with water and glycerol, respectively. The calculated surface free energy for sol-gel deposited steel was 47.26 mJ/m². The wettability results revealed that the sol-gel film improved the surface hydrophilicity of the surface, as indicated by the reduced CA and increased surface energy. The results showed an enhancement in the surface energy of sol-gel deposited steel by 2.7 times compared with the bare sample.

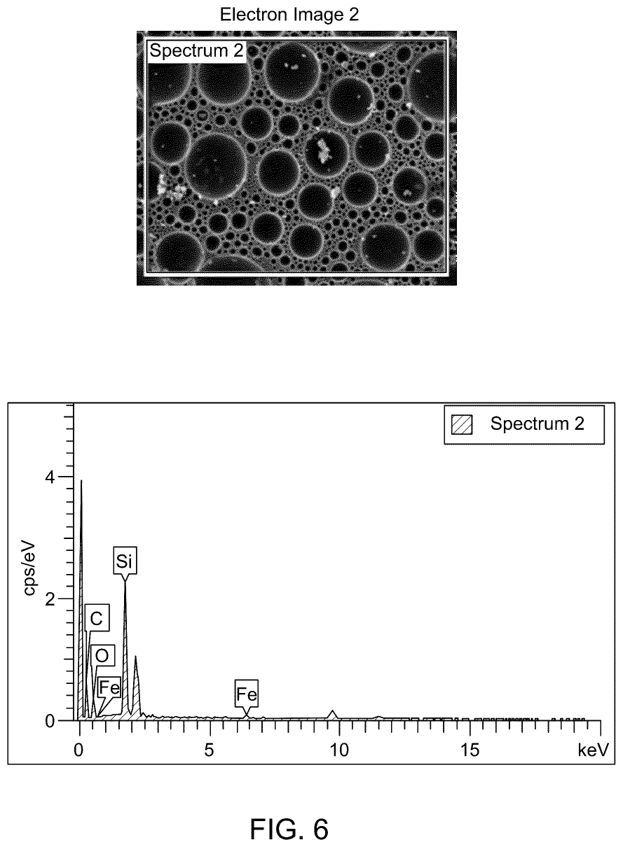

FIGS. 5A-5F display the surface morphological images of the sol-gel and FBE-coated steel surfaces. The SEM image of the sol-gel coated steel surface (FIG. 5A) exhibited a compact and crack-free film with a uniformly distributed porous structure. The diameter of pores ranged from 5 to 20 μm (FIG. 5B). From the EDS analysis of the sol-gel films (FIG. 6), it is clear that the synthesized sol-gel coatings exhibited the prime peaks of silicon and oxygen, confirming the formation of silane films on CS specimen. A cross section SEM image of the interphase made by FBE coating and sol-gel deposited bare CS substrate is presented in FIG. 5F, displaying a dense barrier coating of FBE along with the thin sol-gel film. The SEM image (FIGS. 5D and 5E) of FBE/bare and FBE/sol-gel samples showed the plain and continuous FBE film produced without any visible interfacial defects. The average thickness of the FBE coatings was about 100±10 μm, in agreement with the Elcometer thickness measurements.

### Example 9: Mechanical Durability of FBE Coatings

The hardness and scratch-resistant characteristics were measured using micro indentation to assess the mechanical features of the developed FBE coatings. The maximum load utilized in the micro indentation tests was ˜ 500 mN which caused a penetration depth (PD) of ˜10 μm. As this PD was about 10% of the FBE film's thickness, the impact of the base metallic substrate on the micro indentation experiments was insignificant. FIG. 7A presents the representative load against indentation depth (ID) curves observed for bare and coated steel surfaces.

The area where the indenter and substrate contact is crucial for analyzing indentation data. The contact area is primarily determined by monitoring the residual impression produced on the base substrate in a conventional indentation test. Based on a closer inspection of the loading and unloading area as depicted in FIG. 7A, it is evident that coated substrates showed less ID than the bare ones. Notably, FBE/sol-gel samples displayed the lowermost ID, indicating the improved mechanical feature of FBE coatings with the sol-gel-coated steel surface. The microhardness value of the bare was 206 MPa (FIG. 7B), while the FBE/sol-gel samples exhibited the highest hardness value among investigated coatings, validating the positive role of sol-gel films in improving the mechanical stability of the processed FBE coatings. The higher hardness value (267 MPa) of the FBE/sol-gel sample is probably attributed to the improvement of interfacial adhesive strength and mechanically interlocking phenomenon at the interface enabled by micro corrugation. Hence, the FBE film is converted to durable to endure exterior loading due to the morphological corrugated topographies of the metallic surface, lessening the existence of internal stresses.

The mechanical durability of the prepared FBE coatings against mechanical force was estimated by a scratch-resistant (SR) analysis, and the obtained data are displayed in FIG. 8A, 8D, 8E. By evaluating the SR by exploring the values of critical load (Lc) and assessing their phases along with the scratch shape, the interfacial adhesion strength of FBE coatings can be examined. Further, the interfacial adhesion strength is represented by the Lc that is estimated by a rapid change in the friction force and the acoustic emission signal [M. A. Husseina, Akeem Y. Adesina, A. Madhan Kumar, A. A. Sorour, N. Ankaha, N. Al-Aqeeli, Mechanical, in-vitro corrosion, and tribological characteristics of TiN coating produced by cathodic arc physical vapor deposition on Ti20Nb13Zr alloy for biomedical applications. Thin Solid Films 709 (2020) 138183, which is incorporated herein by reference in its entirety]. Generally, during scratch resistance analysis, three distinct critical loads are observed. The first critical load (Lc1) signifies the load required to observe the primary notable tears on the scratch profile, with the visible underneath the surface. The second critical load (Lc2) is accompanied by the employed load at which the spreading of fracture takes place. Lastly, the third critical load (Lc3) denotes the normal applied load at which the film shows the prominent failure with fractional or broad delamination [S. S. Golru, M. M. Attar and B. Ramezanzadeh, Effects of different surface cleaning procedures on the superficial morphology and the adhesive strength of epoxy coating on aluminum alloy 1050. Prog. Org. Coat. 87 (2015) 52-60, which is incorporated herein by reference in its entirety].

The extracted Lc values for the FBE coatings are presented in FIG. 8A, and corresponding surface micrographs of scratch profiles are revealed in FIGS. 8B and 8C. The higher critical load generally represents the improved adhesion strength of coating towards the base substrate. FBE/sol-gel sample exhibited higher Lc values when compared to the FBE/bare sample, indicating the enhanced performance of interfacial adhesion of FBE coatings on sol-gel coated steel substrates. In addition, FIGS. 8D and 8E show the coefficient of friction (CoF) and penetration depth (Pd), respectively, of the indent in the FBE coatings with the function of the applied force alongside the scratch length. FBE/sol-gel samples showed a higher CoF and lower penetrative depth than that of FBE/bare samples, showing that the interface formed on the FBE and sol-gel coated steel surface is adequately durable against the applied load. The recorded CoF and Pd against the applied load tends to follow a two-stage sequence: (i) At the early stage of the scratch up to about 2N load, the indent penetrates over the entire thickness of the films as revealed by the initial rise in CoF and Pd. The two coatings tend to behave similarly at this stage. (ii) Afterwards, the CoF and Pd reach a steady state before rising again. The steady-state Pd for the FBE/bare coating is about 60 μm while that of the FBE/sol-gel is about 30 μm indicating that the FBE/sol-gel coating exhibited enhanced performance compared to the FBE/bare samples.

### Example 10: Adhesion Tests on FBE Coatings Before and After Exposure

The interphase adhesion strength between metallic substrate and FBE coating is considered a key factor concerning its longstanding performance in operating fields. To estimate the adhesive forces between the FBE and CS specimens, the hydraulic pull-off test was performed before and after exposure to NaCl medium, and the adhesion loss value was calculated using the following formula:

Adhesion loss(%)=Adhesiondry−Adhesionwet/Adhesiondry×100.

The attained results are given in FIG. 9, which shows wet and dry adhesion tests result for the FBE coatings on bare and sol-gel-coated steel specimens. The interfacial adhesion strength of the FBE/bare sample is 11.25 MPa before exposure and 6.55 MPa after 30 days of exposure. The results showed that the FBE on bare specimens exhibited the lowest adhesion strength values before and after exposure to a NaCl medium. The adhesion strength was pointedly reduced in wet conditions, resulting from the negative effects of electrolytic permeation on the FBE coating's adhesion on the steel surface. Alteration of the physical structure of the FBE films due to probable disruptions in the epoxy chains leads to adhesion loss between the metal and FBE coating. The FBE/sol-gel samples showed an adhesion strength of 18.55 MPa before exposure and 16.35 MPa after exposure. Thus, the interface adhesion at the FBE/steel surface was improved after depositing the sol-gel film, revealing the beneficial role of the sol-gel film on the adhesion of FBE coatings. As earlier mentioned, the sol-gel films can enhance both surface roughness profile and surface free energy, combining effective physical and chemical bonding with polar functionalities of the epoxy chain, facilitating the interfacial adhesion strength. The FBE on the bare surface was separated entirely from the CS surface, whereas the disbondment is not fully observable from FBE/sol-gel (both in dry or in wet state), corroborating strong bonding between the FBE coating and sol-gel deposited CS substrate. The calculations have demonstrated that the adhesion loss value for FBE/bare is about 41.77%, while FBE/sol-gel samples are approximately 11.85%, respectively. The obtained results validated that the loss of adhesion for the FBE/sol-gel samples is pointedly lesser in comparison with the bare CS surface, which further demonstrated that sol-gel film not only provided the initial adhesion strength but also the steadiness of adhesive bonds in an aggressive medium could be improved by depositing sol-gel film on the steel surface. These results verified that the sol-gel film's deposition before FBE coatings pointedly enhanced FBE coating's adhesion to the steel surface.

### Example 11: Corrosion Tests

The evolution of OCP values of CS substrates coated with FBE coatings in NaCl medium concerning their exposure period is presented in FIG. 10A. Generally, the OCP value of coated CS sample is signified by both the corrosion potential (E_{corr}) of the metallic substrate and the electrical resistance of the deposited coating. Visibly, the values of OCP monitored for the FBE coatings on bare steel substrate are relatively lower than FBE/sol-gel samples during the 30 days of exposure to the NaCl solution. In other words, the FBE/sol-gel sample exhibited the highest electrical resistance, while the FBE/bare sample showed the lowest one during the entire exposure time in the NaCl medium. Two noticeable variations were understood between the OCP trends of the two investigated coatings. First, the values of OCP for the FBE/sol-gel samples during different times of immersion are much higher than the FBE/bare sample. Another difference is the minor decrease in OCP values at the primary exposure period in the FBE with sol-gel film. These inferred that the existence of sol-gel film effectively reduces the coating disbondment and formation of corrosion products. In addition, the OCP values of coated CS samples directly reflect the corrosion vulnerability of the metallic substrate, and higher OCP lower the corrosion tendency. After immersion of 30 days, the OCP values obtained for the FBE/bare and FBE/sol-gel samples were found to be −0.630 V and −0.112 V, respectively. In addition to the OCP measurements, LPR tests were performed periodically throughout the entire exposing period, and the extracted values of Rp for investigated samples are presented in FIG. 10B. FBE/bare samples exhibited a reduction in the Rp with the immersion time, and these changes with Rp were relatively lower for the FBE/sol-gel samples. The nondestructive test results showed that the sol-gel film on CS substrates before FBE coatings intentionally enhanced the anticorrosion behavior of the FBE films due to the effective interfacial adhesion strength at the interface of the FBE coating and sol-gel coated CS surface.

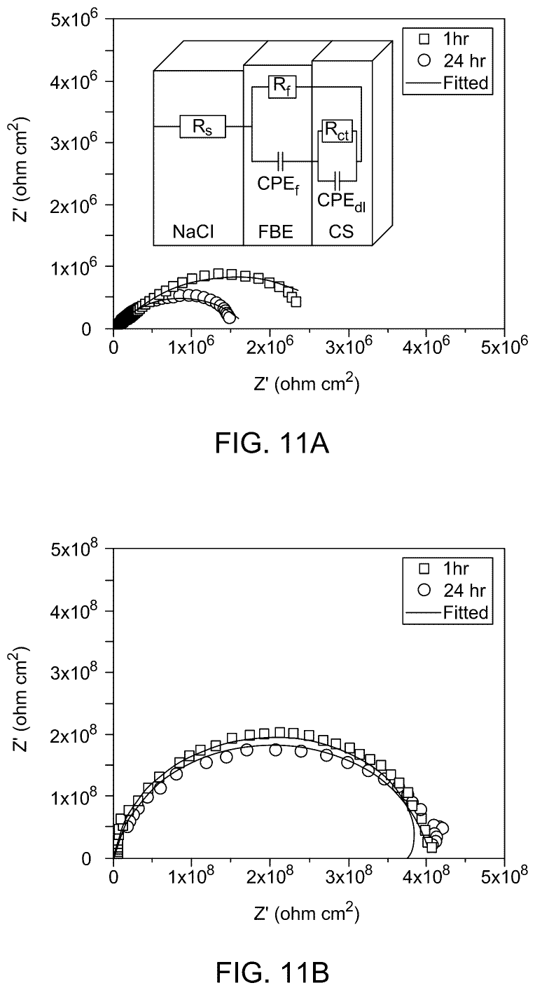

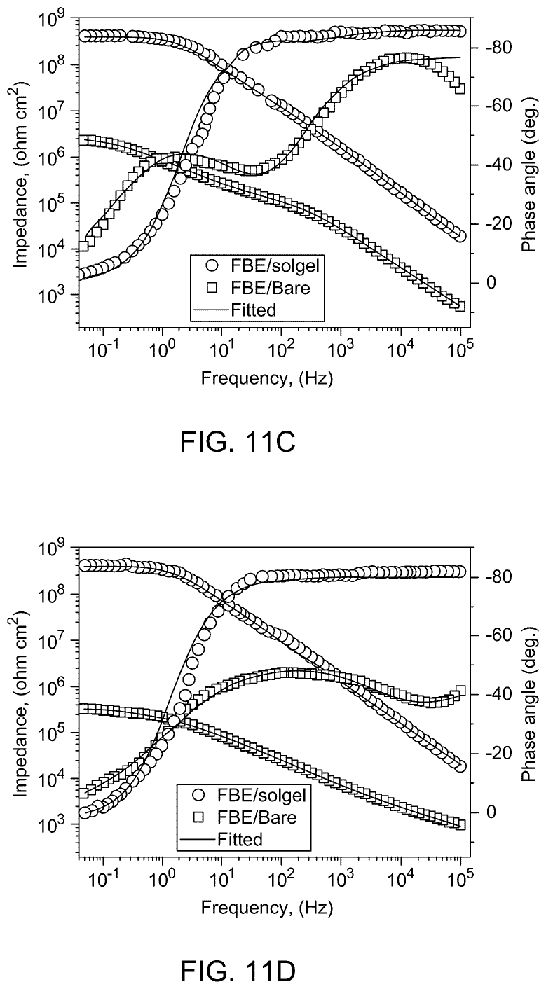

EIS tests were performed periodically on the FBE-coated bare and FBE/sol-gel coated samples in NaCl solution to attain more information on the barrier characteristics and coating's anticorrosion activity. The obtained EIS curves for one-hour and 24-hour immersion in Nyquist and Bode plots are presented in FIG. 11A-FIG. 11D. The Nyquist graphs are depicted in FIGS. 11A-11B, and it displays only one semicircular arc since the two-time constants possess almost the same values and possibly hence overlay. However, Bode curves of both coated steel samples (FIGS. 11C-11D) exhibited the two-time constant behavior, one at a higher frequency, representing the dielectric characteristics of the films, and the other at low frequencies revealing the distinctive behavior of the CS surface exposed to the microdefects of the coatings. The intercept at high frequencies relates to the electrolytic resistance, and the intercept at the low frequencies is equivalent to the sum of the electrolytic and the charge transfer resistance (R_{ct}). In general, the bigger diameter of the semicircle arc represents the material's lower corrosion rate. Bode-resistant plots of both FBE coatings exhibited different shapes, validating the difference in their interface surface chemistry. In addition, Bode phase angle (PA) curves often deliver evidence on the structural variations and surface state of the coated metallic materials, and the accomplished PA curves proved the capacitive performance in the examined frequency range. The variation of the PA as a function of frequencies for FBE/bare and FBE/sol-gel samples is different, showing that the FBE coatings experience different barrier characteristics with and without sol-gel films. The impedance of coated CS samples increased with decreasing frequency from 105 Hz to nearly 1 Hz and then continue at a certain level. At a lower frequency (0.01 Hz), the impedance modulus (|Z|) has been frequently utilized as semi-quantifiable signs for the corrosion protection behavior of coated materials. Bode impedance curves of both coated CS samples verified a pure capacitance behavior, with |Z| higher than 108-ohm cm². These observations validated the characteristic capacitive performance of coated CS substrates, where the FBE coating aids as an active physical barrier to inhibit the CS substrate against corrosion. The associated plateau of PA decreased in the frequency region of 10-0.01 Hz, and the consistent PA continued at almost −90° in the higher frequencies, demonstrating the good physical barrier and interphase adhesion strength of the investigated coatings. Results demonstrated a reducing pattern for impedance modulus during the exposure for the FBE/bare sample; however, for the FBE coating interface altered by sol-gel film, the impedance modulus did not vary significantly.

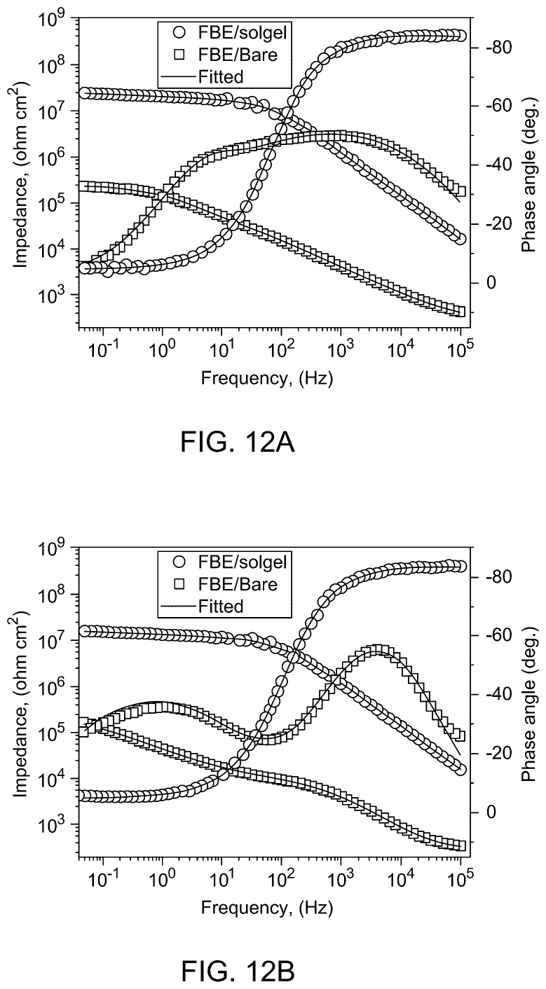

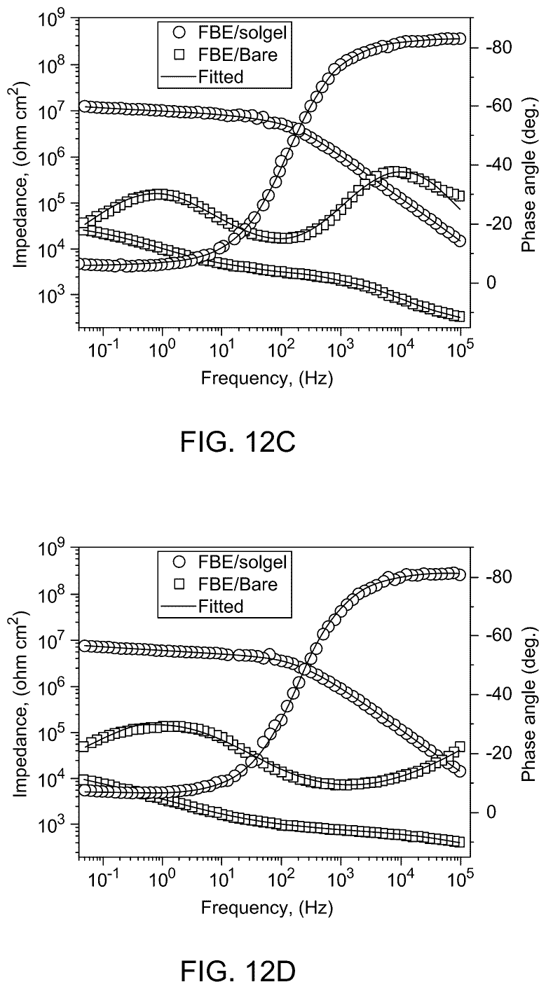

FIGS. 12A-12D show Bode plots of FBE coatings on bare and sol-gel-coated steel specimens during the immersion of 7, 14, 21, and 30 days, respectively, in NaCl medium. After 24 hr of exposure, a reduction by around one order of magnitude occurred on the impedance modulus value for FBE/bare samples, resulting from the penetration of the electrolytic ions into the FBE film and the start of the corrosion phenomenon at the coating/metal interface. Whereas, in the case of FBE/sol-gel samples, it exhibited almost no change in the impedance modulus up to 14 days of immersion. The progress of the Bode PA and impedance curves revealed that the existence of the sol-gel film at the interface of FBE and steel surface could be beneficial to an optimistic level for barrier characteristics of the FBE coating.

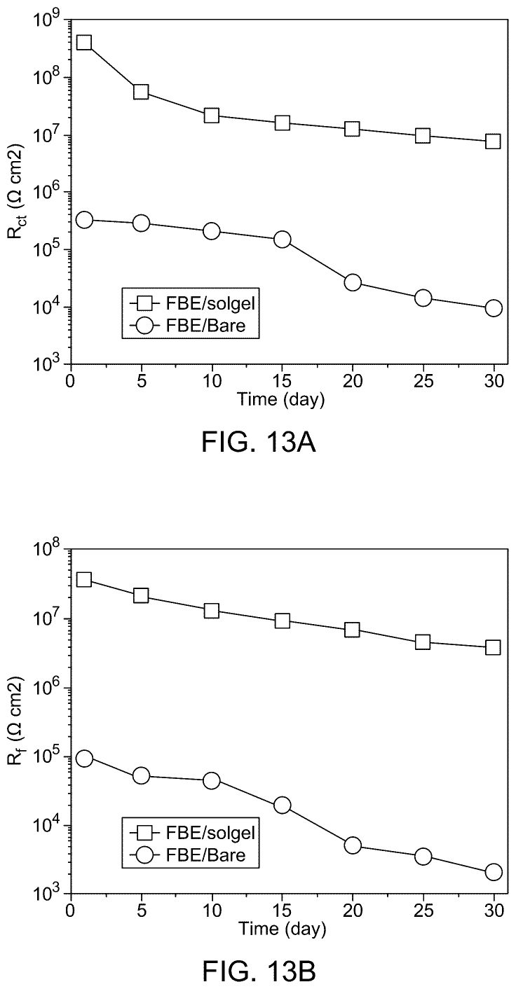

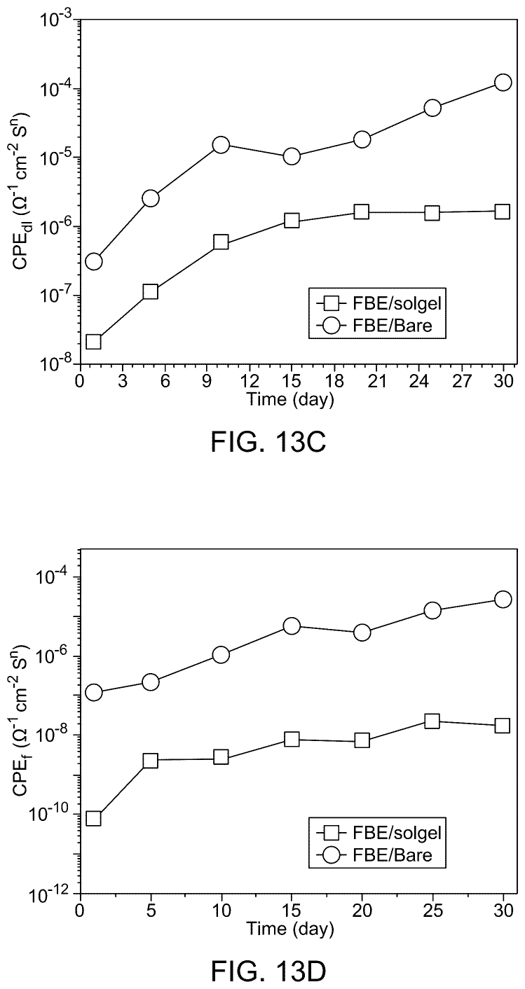

To attain more insight information on the progression of the physical barrier features of the inspected FBE coatings, the raw EIS plots were further investigated using the non-linear regression square method. The electrical equivalent circuit is depicted in FIG. 13A insert was utilized and mentioned that constant phase elements (CPEs) were employed to replace pure capacitors to compensate for the surface heterogeneity, roughness, and potential and current variation of the metallic substrate. The impedance depiction of a CPE is denoted by the following,

$$[ {Z}_{CPE} = 1 / [ {Q ( j ω )}^{α} ] ,$$

where Q denotes the CPE parameter, @ indicates the angular frequency, j denotes the imaginary factor, and a is the frequency dispersion unit.

FIGS. 13A-13D show plots of EIS parameters, R_{ct}, R_{f}, CPE_{dl}, and CPE_{f}, respectively, of the FBE coatings on bare and sol-gel-coated steel specimens against immersion time during the immersion of 30 days in NaCl medium. Ret values of FBE/bare samples (FIG. 13A) were pointedly reduced with increasing immersion periods, while the reducing trend of Rat for the FBE/sol-gel samples displayed minor alteration during the entire exposure period. FBE/bare samples presented a quick decrease in R_{ct} values from 3.32× 10⁶-ohm cm² to 2.56×10⁵ ohm cm² after the 7th day of exposure. Then, there was a significant fluctuation in R_{ct} values, and after that remained constant, with Rat values of 1.02×10⁴-ohm cm² at the 30 days of immersion. Interestingly, the R_{ct} values of FBE/sol-gel samples slightly diminished till the 14th day and then sustained nearly constant at about 7.65×10⁶ ohm cm² in the complete exposure time. The existence of sol-gel films at the interface of FBE and steel can efficiently restrict the paths for the diffusion of violent specie from the exposed solution and, thus, improve the physical barrier features of FBE coating. Further, the variation of Rrvalues against the exposure time is depicted in FIG. 13B, showing that the values of Rr progressively diminished with extending exposure time. After 30 days, the R_{f} value of the FBE/sol-gel sample was around two orders of degrees higher compared to the FBE/bare samples. The improved Rr signifies the beneficial part of sol-gel films at the interface of FBE and steel surface.

The EIS parameter, CPEf, is frequently used to assess aggressive species' permeation into the polymer coatings. The attained CPE_{f} values are presented with the variation of exposure time in FIG. 13D. The values of CPE_{f} for FBE/bare samples were increased with the exposure period, revealing the absorption of water through the FBE film. After 30 days of exposure, closure observation of the CPE_{f} values indicated that the protective barrier activity of this coating was gradually destroyed due to the extended immersion. Besides, the CPE_{f} of the FBE/sol-gel sample is almost unchanged, with slight fluctuation throughout the exposure period; however still lesser than FBE/bare sample, signifying that the dissemination of water and hostile chloride ions is relatively complex in the coating. Generally, higher values of Rr and R_{ct} with lower values of CPE_{dl} and CPE_{f} are essential for an intact coating with effective anti-corrosion characteristics. Compared with the FBE/bare sample, the minor change in the CPE values of FBE/sol-gel samples further validated the significant modification of the physical barrier characteristics of the FBE coatings through sol-gel films. FIGS. 14A-14B present the surface micrographs of the FBE coatings after 30 exposure days to the NaCl medium. Starting the photo digital pictures of the investigated coatings, aggressive damage was noticed on the FBE/bare sample (FIG. 14A) due to the effective corrosion reactions at their interface. SEM images of these samples showed vigorous corrosion attack, as detailed by showing numerous dispersed sites of corrosion products. However, FBE/sol-gel sample (FIG. 14B) exhibited nearly fine and smooth surfaces with no visible corrosion attacks, indicating their enhanced anticorrosion activity in the NaCl medium. From the attained test results, it shows that the presence of sol-gel films at the interface of FBE and steel surface improves the interfacial adhesion strength as well as reduces the diffusion of destructive ions across the FBE film, further enhancing the physical barrier properties of the FBE coating and, subsequently, reduce the corrosion phenomenon at the CS/FBE interphase.

To conclude, FBE coatings were deposited on bare and sol-gel-coated CS samples using an electrostatic spray technique. Surface characterization of sol-gel deposited films confirmed the formation of compact sol-gel films with homogeneous porous morphology with higher uniform surface roughness. The wettability study validated the enhanced surface free energy evidenced as the sol-gel films on the CS surface significantly enhanced the surface energy by 2.7 times compared with the bare sample, which is beneficial in improving the interfacial adhesion strength for the subsequent FBE coatings towards the CS surface. The mechanical durability of the FBE coatings was enhanced by the deposition of sol-gel films at the interface of FBE and steel by exhibiting a higher hardness of 30% compared with the bare and improved scratch-resistant characteristics of the prepared FBE films. Pull-off adhesion strength results of the FBE/sol-gel sample under wet and dry conditions confirmed the enhanced interfacial adhesion strength due to the physical and chemical interactions of the sol-gel films with the FBE matrix. Corrosion test results in NaCl medium validated the improved anticorrosion activity by exhibiting higher impedance and lower capacitance values after 30 days of exposure to NaCl solution. From the obtained results, it is concluded that the overall performance of FBE coatings can be enhanced by the presence of sol-gel films at the interface of FBE films and steel surfaces.

Numerous modifications and variations of the present invention are possible in light of the above teachings. It is therefore to be understood that within the scope of the appended claims, the invention may be practiced otherwise than as specifically described herein.

1. A method for enhancing adhesion of a curable epoxy resin composition to a metal article, comprising:
applying a sol-gel mixture on a surface of the metal article and aging to form a sol-gel layer on the metal article;
electrospraying the curable epoxy resin composition on the sol-gel layer of the metal article; and
curing the curable epoxy resin composition by heating thereby forming a fusion-bonded epoxy (FBE) layer on the sol-gel layer;
wherein the sol-gel layer is between the surface of the metal article and the FBE layer;
wherein the curable epoxy resin composition comprises an epoxy monomer and a phenolic curing agent;
wherein the FBE layer has a thickness of 70 to 130 micrometers (μm); and,
wherein the sol-gel layer has an average thickness of 10 to 100 μm.

2. The method of claim 1, wherein the sol-gel layer has a porous, rough, textured surface comprising irregular hills and valleys, and wherein a plurality of pores are homogeneously distributed throughout the sol-gel layer.

3. The method of claim 2, wherein the sol-gel layer comprising the irregular hills and valleys has an arithmetic mean height deviation (Ra) of 6.5 to 10.5 μm, a root mean square height (Rq) of 7 to 11 μm, a maximum peak height (Rp) of 30 to 40 μm, a maximum valley depth (Rv) of −8 to −4 μm, and a ten-point height (RT) of 60 to 80 μm.

4. The method of claim 2, wherein the pores have an average diameter of 5 to 20 μm.

5. The method of claim 1, wherein the sol-gel layer comprises one or more siloxane (—Si—O—Si—) bonds.

6. The method of claim 1, wherein the sol-gel layer on the metal article has a water contact angle of 50 to 55 degrees (°), and a glycerol contact angle of 51 to 56°.

7. The method of claim 1, wherein the metal article comprises at least one metal selected from the group consisting of a carbon steel (CS), a carbon steel alloy, and a mild steel.

8. The method of claim 7, wherein the metal article is made of carbon steel, and wherein the carbon steel comprises 0.1-0.6 wt. % Mn, 0.1-0.6 wt. % Si, 0.05-0.4 wt. % C, 0.01-0.1 wt. % Al, 0.01-0.1 wt. % Al, and Fe as a balance, as determined by Energy-dispersive X-ray (EDX) spectroscopy, and wherein each wt. % based on a total weight of the metal article.

9. The method of claim 1, wherein the metal article is part of a casing, a pipe, a pump, a screen, a valve, or a fitting of an oil or gas well.

10. The method of claim 1, wherein a mole ratio of the epoxy monomer to the phenolic curing agent is in a range of 10:1 to 1:1.

11. The method of claim 1, wherein after the curing the FBE of the FBE layer has a cross-linking degree of 60 to 95% based on a total number of the epoxy monomer and the phenolic curing agent.

12. The method of claim 1, wherein the curable epoxy resin composition comprises at least one resin selected from the group consisting of a bisphenol A epoxy resin, a bisphenol F epoxy resin, a novolak epoxy resin, an aliphatic epoxy resin, a glycidylamine epoxy resin, an epoxidized vegetable oil, and a mixture thereof.

13. The method of claim 1, wherein the phenolic curing agent comprises one or more phenolic hydroxyl groups.

14. The method of claim 1, wherein the electrospraying further comprises:
mixing the epoxy monomer and the phenolic curing agent to form the curable epoxy resin composition;
dispensing and atomizing the curable epoxy resin composition via a nozzle of a spray gun of an electrostatic spray unit to generate droplets of the curable epoxy resin composition at an output voltage of 80 to 100 kilovolts (kV); and
wherein a distance between the nozzle of the spray gun and the sol-gel layer is in a range of 100 to 150 millimeters (mm);
passing the droplets through an electrostatic field generated by an electrode of the electrostatic spray unit onto a surface of the sol-gel layer of the metal article to form a coating layer on the surface of the sol-gel layer; and
wherein the passing is performed under an air pressure of 0.5 to 0.8 megapascal (MPa).

15. The method of claim 1, wherein the curing by heating is performed at a temperature of 150 to 250 degree Celsius (° C.).

16. The method of claim 1, further comprising:
preparing the sol-gel mixture by:
mixing one or more silane compounds (—Si—O—R) in a first solvent to form a silane mixture;
mixing an acid, a second solvent and the silane mixture to form the sol-gel mixture;
wherein the one or more silane compounds are hydrolyzed in the presence of the acid in the sol-gel mixture during the aging to form one or more silanol (—Si—O—H) compounds that can further react to form the sol-gel layer.

17. The method of claim 16, wherein the one or more silane compounds comprise (3-aminopropyl) trimethoxysilane (APTMS), dimethoxy-methyl-octadecylsilane (DMMOS), tetraethyl orthosilicate (TEOS), and 3-glycidyloxypropyl-trimethoxysilane (GPDMS).

18. The method of claim 16, wherein the first solvent is at least one of isopropyl alcohol (IPA), methanol, ethanol, and butanol; wherein the second solvent is at least one of methanol, and ethanol; and wherein the acid is at least one of a hydrochloric acid (HCl), a sulfuric acid (H₂SO₄), a nitric acid (HNO₃), phosphoric acid (H₃PO₄), an acetic acid, and a hydrofluoric acid (HF).

19. A metal article treated by the method of claim 1, wherein the surface energy of the FBE layer to the metal article is improved by 2.7 times compared to that of the FBE layer in the absence of the sol-gel layer.

20. The metal article of claim 19, wherein the FBE layer has a pull-off adhesion strength to the metal article in a range of 12 to 20 MPa as determined by ASTM D4541.
